(19) United States
(12) Patent Application Publication
(10) Pub. No.: US 2004/0246650 A1
(43) Pub. Date: Dec. 9, 2004

(54) Highly conductive macromolecular materials and improved methods for making same

(76) Inventors: Leonid N. Grigorov, Novato, CA (US); A. Ze'ev Hed, Nashua, NH (US); Dmitry N. Rogachev, Santa Rosa, CA (US); Kevin P. Shambrook, Petaluma, CA (US); Alan W. Tamarelli, Basking Ridge, NJ (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 10/685,993

(22) Filed: Oct. 14, 2003

Related U.S. Application Data
(63) Continuation-in-part of application No. 10/370,148, filed on Feb. 18, 2003, now Pat. No. 6,804,105.
Application No. 10/370,148 is a continuation of application No. 09/370,101, filed on Aug. 6, 1999, now Pat. No. 6,552,883.
(60) Provisional application No. 60/095,607, filed on Aug. 6, 1998.

(51) Int. Cl. H02H 1/00

(52) U.S. Cl. 361/212

(57) ABSTRACT

Methods of activating, enriching, manipulating, and producing macromolecular materials comprising highly conductive multielectron threads are provided together with superior such materials and devices comprising them. Activation methods such as doping the material with charged or uncharged dopants, using electrolysis techniques, and charging the material may be combined with various enrichment techniques that take advantage of reduced viscosity levels such as filtering and fractionation to obtain very high yields when producing conductive films, wires, and diamagnetic materials. Also disclosed are methods for electrically joining conductors and various devices comprising highly conductive macromolecular materials.

### CROSS-REFERENCE TO RELATED APPLICATIONS

This application is a continuation-in-part of U.S. patent application Ser. No. 10/370,148 filed Feb. 18, 2001, which is a continuation of U.S. patent application Ser. No. 09/370,101 filed Aug. 6, 1999, now U.S. Pat. No. 6,552,883 issued Apr. 22, 2003, which claims priority from U.S. Provisional Patent Application 60/095,607 filed Aug. 6, 1998, all of which are incorporated herein by reference.

### FIELD OF THE INVENTION

This invention relates generally to macromolecular materials having high electrical conductivity and improved methods for making such materials. More particularly, it relates to highly conductive materials formed from high molecular weight compounds and techniques for producing such materials.

### BACKGROUND OF THE INVENTION

U.S. Pat. No. 5,777,292, which is hereby incorporated by reference, was granted to two of the present inventors. It discloses a new type of macromolecular material having high conductivity at room temperatures. Because of the unique properties of this conductive material, it would be desirable to improve upon its properties, to provide various alternative types of such materials, to develop improved methods for producing these materials, and to provide new and useful applications for them.

### SUMMARY OF THE INVENTION

The present invention provides various types of materials having high conductivity at room temperatures, improved methods for producing, enriching, and/or manipulating such materials, as well as various practical technological applications and uses of such materials. In one aspect of the invention, such materials are produced by forming a medium of macromolecular substance, generating free electrons in the medium, and inducing these electrons to form electronic threads and/or channels within the medium. The macromolecular substance may be a polymer such as a hydrocarbon modified by oxygen. For example, the macromolecular substance may be oxidized atactic polypropylene, oxidized isotactic polyhexene, a polyurethane, or polydimethylsiloxane. The materials may be produced in various forms including but not limited to thin films, membranes, blocks, wires, matrices, and aerogels. The materials may have an anisotropic electric conductivity, typically in a direction normal to the surface in the case of a membrane or film.

According to one aspect of the invention, the generation of free electrons within the medium is assisted by one of various techniques such as, for example, doping the medium.

According to another aspect of the invention, enrichment techniques are used to increase the number and/or concentration of existing free electrons and/or electronic threads in the medium. These and other methods may be used to produce, with much higher yields than were previously possible, materials which have electronic channels and/or threads whose room temperature conductivity may be greater than 10⁶ S/cm, or as large as 10⁷ S/cm, or even 10⁸ S/cm or more in some cases. The techniques can also be used to form materials exhibiting diamagnetism. The conductivity is substantially temperature independent up to near the destructive temperature for the medium.

One aspect of this invention relates to the addition of particular dopants to the macromolecular material. Dopants may be, for example, electrons, ions, compounds that ionize at a low energy level, or compounds that enable the ionization of other materials. The dopants alter the properties of the medium by enhancing the production of free electrons in the medium. As a result, dopants can increase the density of conductive threads in the material, facilitate the production of enriched materials, improve the yield of laboratory samples and production processes, and thereby reduce the cost of manufacturing these materials. The use of dopants facilitates ionization in thicker films, or in bulk, since the ionization is not limited to the surfaces of the film. This leads to economies of time and equipment for the manufacturing processes which is a great benefit, even in the case where the useful characteristics of the end product (such as its conductivity) may not be different.

In another aspect of the invention, methods are provided for introducing charge to the macromolecular medium, again enhancing the production of free electrons. According to one method, additional electrons are added to the medium by contact with another charged material, or a material in contact with the medium is charged, thereby charging the medium.

Another aspect of the invention provides techniques involving lowering the viscosity of the medium, after conductive threads are formed, while preserving most of the conductive threads. Various production, enrichment, and manipulation techniques involving highly conductive materials are in many cases improved or made possible by working with a lower viscosity medium. An example of such a process is filtering, which can be used to separate the conductive threads from the bulk of the medium, creating an enriched material which has a high concentration of conductive threads. Such enriched materials may be used to enable or increase the yield of certain techniques for producing wire, thicker films, diamagnetic materials, and other products. For example, the low viscosity medium enables the production of thick films, preferably by forming successive layers. Low viscosity medium also enables or improves new techniques for making wires. Wire production often requires the attraction of conductive threads to the end of the wire as it grows. These threads move much faster and with less force required when in a low viscosity medium. Hence the manufacturing speed and productivity for wire and other devices is greatly enhanced. Thus, other aspects of the invention include various types of materials, products, and devices that incorporate highly conductive materials, and methods for making such.

### BRIEF DESCRIPTION OF THE DRAWINGS

FIG. 1 shows the chemical structure of APP, a polymer used to produce a conductive material according to a preferred embodiment of the invention.

FIG. 2 shows the chemical structure of IPH, a polymer used to produce a conductive material according to a preferred embodiment of the invention.

FIG. 3 shows the chemical structure of two forms of PDMS, a polymer used to produce a conductive material according to a preferred embodiment of the invention.

FIG. 4 shows the chemical structure of a PDMS copolymer, a polymer used to produce a conductive material according to a preferred embodiment of the invention.

FIG. 5 shows the chemical structure of yet another form of PDMS, a polymer used to produce a conductive material according to a preferred embodiment of the invention.

FIG. 6 shows the chemical structures of two components used to form a polyurethane, a polymer used to produce a conductive material according to a preferred embodiment of the invention.

FIG. 7 shows the chemical structures of the polyurethane produced by the copoly-condensation of the two polymers shown in FIG. 6.

FIG. 8 illustrates a technique developed by the inventors for increasing the concentration of conductive elements in the macromolecular medium.

FIG. 9 illustrates a technique devised by the inventors for increasing the length of conductive elements by joining conductive elements together.

FIG. 10 shows an embodiment of the invention in the form of a thin film with conductive channels passing from one side to the other.

FIG. 11 illustrates a technique developed by the inventors for creating long conductive threads in a macromolecular medium.

FIG. 12 illustrates the technique used by the inventors for testing the electrical properties of a conductor of the invention.

FIG. 13 is a schematic diagram of a circuit to improve the conductive properties of a material of the invention.

FIG. 14 is a cross-sectional diagram illustrating an electrical interposer employing a conductive material of the present invention.

FIG. 15 is a cross-sectional diagram illustrating a conventional thermoelectric device.

FIG. 16 is a cross-sectional diagram illustrating a thermoelectric device employing a conductive material of the present invention.

FIG. 17 is a cross-sectional diagram illustrating a thermal barrier employing a conductive material of the present invention.

FIG. 18 shows an apparatus for implanting dopants using electrolysis, according to one embodiment of the invention.

FIG. 19 shows an apparatus for implanting dopants using electrolysis, according to another embodiment of the invention.

FIG. 20 shows an apparatus for implanting ions from a plasma, according to one embodiment of the invention.

FIG. 21 shows an apparatus for activating a macromolecular medium using a high voltage microtip, according to one embodiment of the invention.

FIG. 22 illustrates one technique for charging a macromolecular medium using a dielectric substrate according to one embodiment of the invention.

FIG. 23 illustrates a technique for charging a macromolecular medium using a conductive substrate according to another embodiment of the invention.

FIG. 24 illustrates aspects of an activation technique according to an embodiment of the invention.

FIG. 25 is an apparatus illustrating another enrichment method employing fractionation according to an embodiment of the present invention.

FIG. 26 illustrates an apparatus used to implement a dielectrophoresis technique according to an embodiment of the invention.

FIG. 27 is an apparatus illustrating an enrichment technique of one embodiment of the invention employing a cross-flow filter.

FIG. 28A illustrates an enrichment technique employing a syringe filter according to an embodiment of the invention.

FIGS. 28B-C illustrate a technique of backflushing which may be used in conjunction with the enrichment technique shown in FIG. 28A.

FIGS. 29A-B illustrate another filtering technique using a filter that can itself be dissolved in accordance with an embodiment of the invention.

FIGS. 30A-D illustrate an enrichment technique based on diffusion of the macromolecular matrix according to an embodiment of the invention.

FIG. 31 illustrates a layering approach to producing a thick conductive film according to an embodiment of the invention.

FIG. 32 is an illustration of an apparatus used to implement a technique for forming a highly conductive wire according to an embodiment of the invention.

FIG. 33 illustrates a device used to implement an embodiment of the invention in which longer wires are made by a continuous process.

FIG. 34 shows an apparatus used to make a conductor from a low viscosity medium according to an embodiment of the invention.

FIG. 35 shows an apparatus used to implement a technique a continuous process for making a wire from a low viscosity medium according to an embodiment of the invention.

FIG. 36 illustrates a close-up view of how two conductors may be electrically joined with highly conductive threads according to an embodiment of the invention.

FIG. 37 provides a view of an apparatus used to perform the electrical joining shown in FIG. 36.

FIG. 38 shows a technique for simultaneously joining several conductors according to an embodiment of the invention.

FIG. 39 illustrates an apparatus that may be used to implement a method for producing a diamagnetic material according to an embodiment of the present invention.

FIG. 40 illustrates a device which may be used for measuring a magnetic field using a diamagnetic material according to an embodiment of the present invention.

FIG. 41 illustrates the basic principle a device in which levitating the diamagnetic material is performed, according to an embodiment of the present invention.

FIG. 42 illustrates a device for shielding a region from a magnetic field using a highly diamagnetic material according to an embodiment of the present invention.

FIGS. 43A-B illustrate how a diamagnetic material can be used to shape or alter a field according to an embodiment of the present invention.

### DETAILED DESCRIPTION

### Theoretical and Experimental Background

The conductive materials discussed herein are derived in part from two discoveries. A first discovery is that certain macromolecular substances may, under certain conditions, contain free electrons able to conduct electric current. The macromolecules in such macromolecular substances typically contain polar groups (e.g. >C═O, —HC═O, —OH) having a large dipole moment and typically have a low percentage of double bonds (i.e., low degree of conjugation). Note that the large dipole moment in some compounds may be provided by the elements in the main chain (e.g., Si—O) rather than side groups.

Without being bound to any particular model, following is one possible explanation for the observation of conductivity in these substances. Due to the high flexibility of the long macromolecular chains while in the viscous liquid state, the polar groups can easily change their spatial positions and orientations. As a result, the substance is endowed with a high static dielectric constant and has properties close to those of low molecular weight polar solvents. Because electrolytic dissociation in polar solvents leads to spontaneous charge separation, some small concentration of free positive and negative charges will appear. It is hypothesized by the inventors that a similar process takes place in the case of many macromolecular substances provided they are in a viscous state and have polar groups. However, rather than the production of negative ions, as in the case of electrolytic dissociation, in this case free electrons appear that are surrounded by oriented dipole groups. These free electrons are called “solvated electrons” or “polarons.” Experimental observations indicate that equilibrium concentrations of these polarons range from 10¹⁴ to 10¹⁸ polarons per cm³. The polarons do not appear to be bonded to specific parent macromolecules in a flexible liquid macromolecular medium. The free movement of polarons, however, may be inhibited or prevented if the macromolecules have a significant number of conjugated bonds which can effectively trap the free electrons in empty electron energy levels. In certain macromolecular substances, therefore, the substance can experience self-ionization and the charges produced can remain free, at least within small localized regions.

A second discovery made by the inventors is that it is possible to dramatically increase the electron mobility in such substances. For example, the inventors have observed conductive threads capable of carrying current between separated portions of the material. Again, without being bound to any specific model, one possible explanation for this phenomenon is as follows. Under certain conditions multiple solvated electrons may join together to form a stable, multielectron conductive structure, which may be variously termed a superpolaron, quantum nanowire, ultraconductive structure, or fibril. Specifically, if a sufficiently self-ionized macromolecular medium has a sufficiently low viscosity, multiple solvated electrons may join spontaneously or be induced to join to form a fibril. At the same time, if the medium has a sufficiently high viscosity, the fibril will remain stable. These fibrils, in turn, may join to form highly conductive threads or channels in the macromolecular material.

The inventors have made an additional discovery that it is possible to increase the stability of the fibril and/or thread once it is formed. For example, suitable polymers can be used whose state may be changed from viscous liquid to solid after the creation of fibrils. After such a transition, the conductivity becomes very stable and thereby suitable for various useful applications.

As will be described in further detail below, the inventors have made additional discoveries that provide new materials and improved methods for making such highly conductive materials. These methods, for example, include techniques that increase yield, reduce production costs, and/or provide end products having desirable properties.

### Definitions

In view of the above considerations, the following definitions provide a basis for clear and definite interpretation of various terms used in the context of the present description.

A “macromolecular material” or “macromolecular substance” is defined to be a material of which a significant percentage is composed of molecules having molecular weights of at least 2 kDa. “Significant percentage” in this context means more than 50 volume %, preferably more than 20 volume %, and more preferably more than 5 volume %. In some cases the molecules preferably have a molecular weight of at least 15 kDa, while in other cases at least 300 kDa. By way of example, a macromolecular material is defined to include, but is not limited to, materials containing a significant percentage of hydrocarbons, polyurethanes, silicon-oxygen based polymers, biological polymers, copolymers, homopolymers, terpolymers, block polymers, polymer gels, polymers containing plasticizing substances, or various mixtures thereof. This definition of macromolecular material is exclusive of pure metals, crystals, and ceramics, although this definition includes macromolecular materials that are doped or mixed with relatively small amounts of low molecular weight organic and inorganic substances, metal, crystal, ceramic, or other such materials.

A “macromolecular medium” is defined as a macromolecular material with the possible addition of one or more solvents or other low molecular weight substances, such as dopants.

A “dopant” is defined as a material which, when present in, or added to the macromolecular material, alters the proclivity or capacity for free electrons to form in the macromolecular material. Typically, dopants constitute less than 1 weight % of the macromolecular material. Note that, in contrast to its meaning in the context of semiconductors, a dopant in the present context does not necessarily alter the conductivity of the material. Dopants may be high or low molecular weight, organic or inorganic, charged or neutral. Charged dopants may be electrons or ions. An ion dopant may be ionized before or after being introduced into the material. Ion dopants that are ionized prior to being added to the material are called “ion additives.”

In the present description, a “free electron” is defined to be an electron that is not bonded individually to any specific macromolecule.

A “polaron” is defined as a single free electron that is solvated within a polar macromolecular medium.

A “superpolaron” or “fibril” in this description is defined to be an elementary conductive constituent in a dielectric macromolecular material with conductivity greater than 10⁶ S/cm.

The term “thread” is defined as one or more fibrils bundled together in mutual contact within a dielectric macromolecular medium forming a quasi-one-dimensional conductive structure comprising free electrons and associated macromolecules.

The term “channel” is defined as a thread within sufficient proximity to the surface of the medium in at least two distinct locations that electrical conduction may be established through the thread by contacting the surface. Typically, a channel in a film provides electrical conductivity through the film from one surface to the opposite surface. This definition, however, does not exclude other types of channels, such as channels providing conductivity between two separate points on the same surface, or channels providing conductivity between multiple points on several surfaces.

“Parallel channels” are defined as channels which are non-contacting and all lie within a small angle of each other, where “small angle” is defined to mean less than 30 degrees, preferably less than 20 degrees and more preferably less than 10 degrees.

In the present description a “highly conductive” material is defined to be a material containing threads having conductivity greater than 10⁶ S/cm, preferably greater than 10⁷ S/cm, and most preferably greater than 10⁸ S/cm, for temperatures below the temperature of decomposition of the material. The threads in such a highly conductive material do not necessarily form channels through the material, but may be organized or distributed in any way within the material. To give just one example, the threads may form many isolated highly conductive loops within the material, contributing to diamagnetic properties. Such a diamagnetic material is thus considered one type of highly conductive material, even though the conductivity may be localized within isolated threads.

A “stable” or “stabilized” material is defined to be a material providing long term stability of highly conductive properties, where “long term” means at least 30 days, preferably greater than one year, more preferably greater than ten years.

A “viscous liquid” material is defined to be a material which exhibits plastic flow under any pressure exceeding surface tension pressure, said flow being measurable within one minute.

The term “room temperature” is defined to include any temperature within the range from 275 K to 325 K,, and preferably temperatures within five degrees of 295 K.

The term “near room temperature” is defined to include any temperature within the range from 250 K to 350 K.

An “enrichment” or “enriching process” is defined to be a procedure that increases the number or concentration of free electrons in a macromolecular medium beyond the original number or concentration before enrichment. Similarly, an “enriched material” is defined to be a macromolecular material with a plurality of threads whose concentration of free electrons is at least 10¹⁸ free electrons per cubic centimeter, preferably at least 10¹⁹ free electrons per cubic centimeter, and more preferably at least 10²⁰ free electrons per cubic centimeter.

An “enriched medium” is defined as a medium that results in an enriched material when the solvent or other low molecular weight substances are substantially removed.

### Methods of Producing Highly Conductive Materials

In general outline, one method for producing highly conductive materials comprises the following steps. First, an appropriate initial chemical compound is chosen. This initial compound is preferably a macromolecular substance, and is typically formed as a film. The initial compound is activated or ionized so that free electrons (polarons) are generated in the macromolecular medium. This activation may be spontaneous or facilitated by various techniques including, for example, doping and/or electrically charging the material. Fibrils are then formed in the activated substance. The formation of fibrils is normally associated with an appearance of, and subsequent increase in, the ferromagnetic susceptibility of the substance. Various techniques may be used to facilitate or speed up the creation of fibrils and/or to increase the concentration of fibrils to produce an enriched material. For example, the medium may be solvated or heated to reduce its viscosity, and then subjected to an enrichment process such as, for example, filtering, fractionating, precipitating, and/or other separation techniques. Conductive threads, wires, or other conductive structures are then formed from the fibrils using one or more techniques to manipulate or process the medium and the fibrils contained therein. The substance may then be stabilized. Note that some of these steps may in some cases take place simultaneously with each other, and in other embodiments, some of these steps may be absent. It should also be noted that some end products may have a low concentration of fibrils even though a concentrated enrichment process may have been used in their production.

Choosing the Initial Compound

Various macromolecular substances can be chosen as the initial compound. Typically, in their initial unactivated state, all of them are quite good electric insulators, have more than 76.8% single bonds, and have molecular weights more than 2 kDa. In some embodiments the substance preferably has an initial static dielectric constant less than 2.4. The substance in its final state, however, may have a static dielectric constant greater than 2.4. The initial compounds typically fall into three broad classes: hydrocarbons, silicon-oxygen based polymers, and polyurethanes produced by copolycondensation of two components. In the case of hydrocarbons, the compound may be, for example, atactic polypropylene (APP) or isotactic polyhexene (IPH).

A. APP

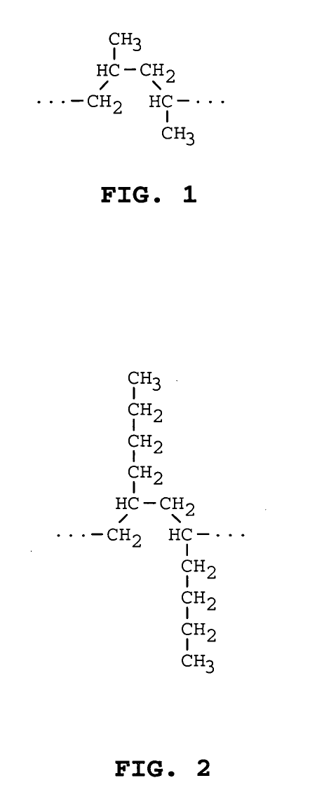

APP has the chemical formula (—C₃H₆—)n and has the chemical structure shown in FIG. 1. In some embodiments, the APP molecules have a molecular weight from 4 kDa to 100 kDa. Molecular weights more than 100 kDa can be used also but these are generally more difficult to synthesize. The main chain of APP is made of carbon atoms. The side groups are hydrogen atoms and methyl groups directed randomly along the chain, causing APP to be completely amorphous. In the bulk, APP molecules are linked only by weak Van der Waals forces, making APP a viscous liquid at room temperature. The structure of APP may be stabilized by cooling below the glass transition temperature (≈−20 C). In order to purify APP prior to preparing an electrical conductor it is often useful to dissolve it in heptane.

B. IPH

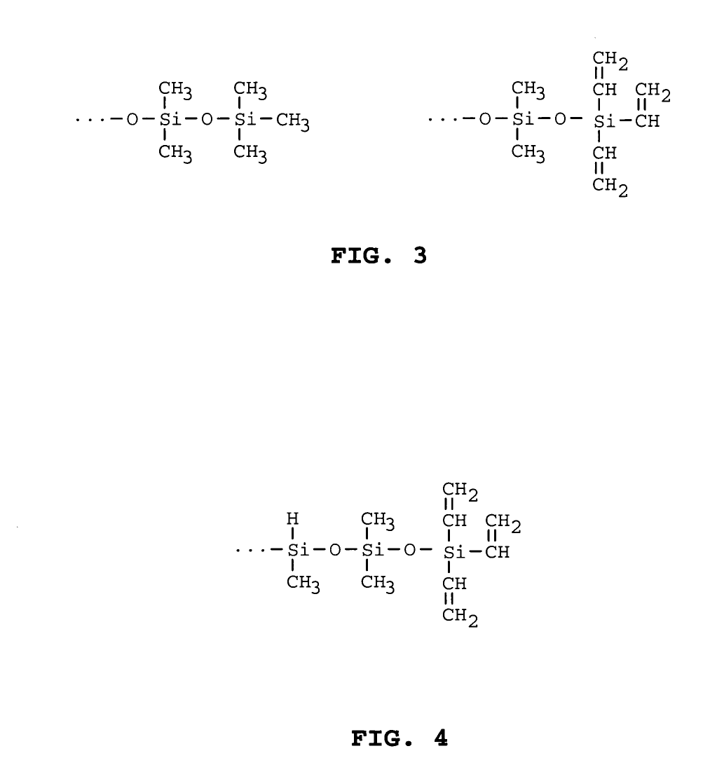

The second hydrocarbon that may be used as the initial compound is IPH which has the chemical formula (—CH((CH₂)₃CH₃)CH₂—)ₙ and the chemical structure shown in FIG. 2. The IPH molecules used may have a molecular weight from 300 kDa to 1,000 kDa. High molecular weight IPH molecules can be easily synthesized because of the regular (isotactic) intramolecular structure. The long side groups in IPH prevent any crystalline structure from developing in the bulk. In order to stabilize IPH one may cool it below its glass transition point (≈−55 C).

C. Silicon-Oxygen Polymers: PDMS and Alterations Thereof

There are various silicon-oxygen polymers that may be used as the initial compound for the formation of an electrical conductor. They are based on a chain of the form (—Si—O—)ₙ, with variations on the side groups and end groups. Because this main chain has such a high flexibility, these polymers have a highly amorphous structure and their glass transition point is typically low (usually around —130 C).

One type of useful silicon-oxygen polymer is polydimethylsiloxane (PDMS). In one embodiment, the PDMS polymer has three methyl end groups at each end of the chain and has a molecular weight more than 300 kDa. In an alternate embodiment, the PDMS polymer has three vinyl end groups at the end of each chain and has a molecular weight more than 15 kDa. The chemical structures of these compounds are shown in FIG. 3.

In the case where PDMS has methyl end groups, chemical bonds between the PDMS molecules do not normally form. Consequently, this substance is a viscous liquid at room temperature and its stabilization is accomplished by cooling below the glass transition point. On the other hand, in the case where PDMS has vinyl end groups, it is also initially a viscous liquid at room temperature, but it may be stabilized through cross-linking, i.e., breaking the double bonds of the vinyl end groups and forming chemical bonds between PDMS molecules. This chemical reaction can be induced at the desired moment by an appropriate catalyst or by heat. The cross-linking transforms the viscous liquid into a solid. Because cross-linking is possible in this case, the molecular weight does not need to be as high as when cross-linking does not take place. This has the advantage that activation and formation of fibrils can take place much faster when the molecules are smaller.

Another type of silicon-oxygen polymer is identical to the compound just described except that some of the methyl side groups are replaced by hydrogen to form a copolymer, as shown in FIG. 4. The substitution of hydrogen atoms permits quicker and stronger stabilization when cross-linking because the hydrogen can easily link with the vinyl end groups. Smaller molecules (down to as small as 2 kDa) may be used in order to increase the number of ends that can cross-link and increase the stability. With this molecule, the preferred fraction of methyl side groups that are replaced with hydrogen is 25%.

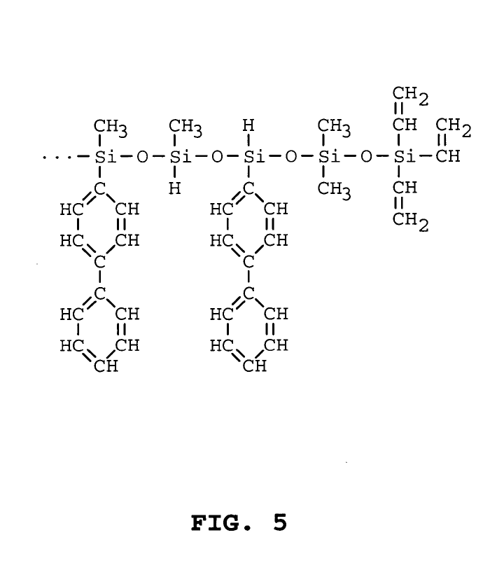

In order to increase the density of cross-linking and improve stabilization, it may be desirable in some cases to decrease the number of links in the main chain without decreasing the molecular weight. One way to accomplish this is to substitute large diphenyl groups for the methyl side groups. This can be combined with the substitution of hydrogen side groups as discussed above. An example of such a copolymer is shown in FIG. 5.

Conductors may also be formed through a combination or mixture of several of the above polymers and copolymers. One such mixture is PDMS having methyl end groups mixed with the copolymer having vinyl end groups and diphenyl side substitutes. Another such mixture is the copolymer having vinyl end groups and hydrogen side substitutes mixed with the copolymer having vinyl end groups and no side substitutes. Moreover, different side substitutes altogether may be used to provide additional variations of the above polymers. For example, acrylic side substitutes may be used as well, allowing cross-linking under shortwave UV treatment. Other side substitutes also may be used in accordance with these principles in order to obtain the necessary conditions for stabilization. Moreover, other mixtures may be produced to facilitate the creation and stabilization of conductors as well.

D. Polyurethanes

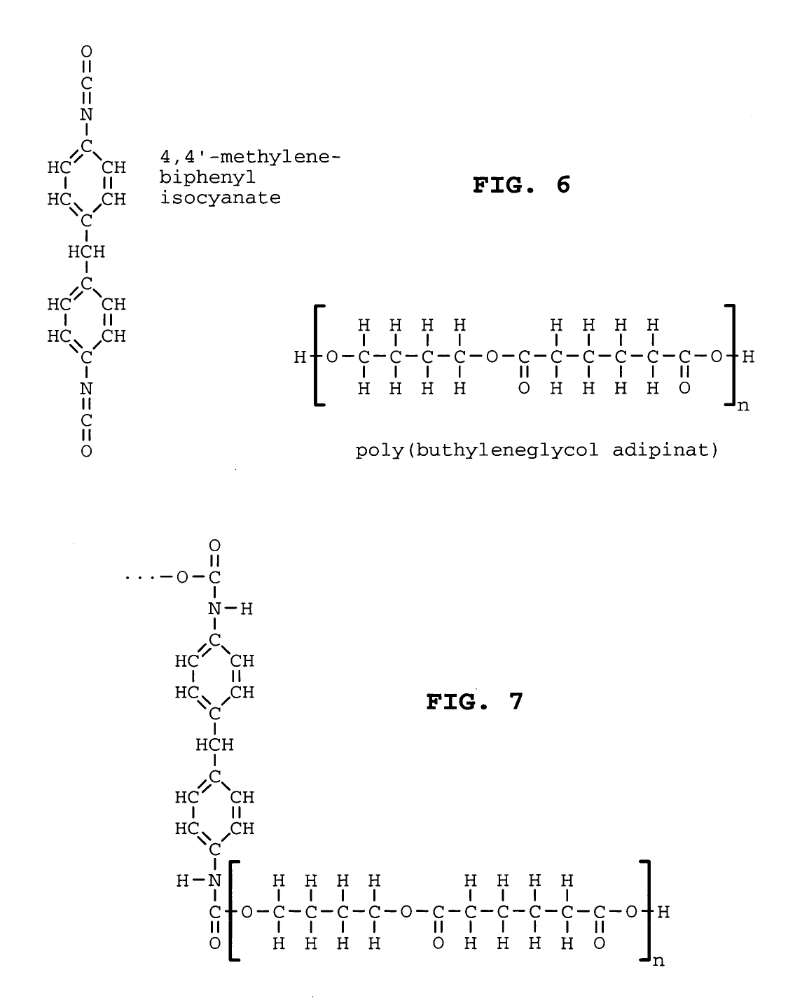

The initial compound used for the creation of the conductor may also be chosen from the class of polyurethanes. For example, the polyurethane may be the product of a copolycondensation of two components, 4,4′-methylenebiphenyl isocyanate and poly-(buthyleneglycol adipinat), whose chemical structures are show in FIG. 6. In one embodiment, the factor n is chosen so that the second component has a molecular weight around 2 kDa. During copolycondensation the two components are connected into large links. The resulting copolymer has the chemical structure shown in FIG. 7. This polymer contains a high concentration of specific chemical groups (i.e., OC═O) having large dipole moment, giving it a larger static dielectric constant of about 4. The oxygen content is preferably between 6.6% and 15.7%, and is more preferably near 12%. The preferred molecular weight of this compound is between 4.5 kDa and 10 kDa. It can be dissolved in various organic solvents, for example, dimethylformamide. In contrast to the previous compounds discussed, this compound may be partially crystallized at room temperature, with the crystalline phase at thermodynamic equilibrium being above 50% by volume. This polymer, however, may be converted to a completely amorphous phase by heating above 62 C. Once fibrils have been formed, it can then be cooled down to room temperature. Note, however, that it may take hours or days for the crystalline content to reach equilibrium.

All the initial chemical compounds discussed above may be used for the electrical conductor preparation, as well as variations of these and alternate compounds as would be obvious to those skilled in the art in view of the teaching contained herein. Indeed, as has been shown through the above examples, an appropriate chemical substance may have quite a different fine chemical structure and may be based on different main chain constructions.

Activating the Compound

The aim of this step is to generate and accumulate stable free electrons in the macromolecular medium. The activation involves one or more techniques which depend in some cases on the particular substance selected. These techniques may include, for example, doping the medium with various types of charged or uncharged dopants, exposing the medium to radiation or electrostatic fields, charging the medium, and other techniques. Some of these techniques may involve reducing the viscosity of the medium by adding a solvent or heating the medium.

Surface Ionization

In several embodiments, free electrons are created in the macromolecular substance by ionizing the surface molecules of the medium. For example, the inventors have discovered that stable free electrons can be created by ionizing molecules adsorbed on the surface with the help of relatively weak ionization factors such as thermofluctuations or exposure to UV radiation. Once a stable macro-ion has been created at the surface, it may then be desorbed from the surface and migrate into the volume of the medium. Because the diffusion can be quite slow, it may take days or even weeks for a high concentration of free electrons to accumulate in the volume of the material. This time can be reduced, however, if the ratio of surface area to volume is very high during the activation stage of the conductor preparation, e.g., by activating the medium while in the form of a thin film or aerogel.

According to one embodiment, activation increases the ratio of surface area to volume by forming a thin film of the macromolecular substance on the surface of a solid substrate. Although films as thick as 100 μm have been produced, preferably the film has a thickness of 20 μm to 30 μm, except for the silicon-oxygen polymer films which have a preferred thickness of 5 μm to 15 μm. The solid substrate in this embodiment could be a metal, glass, semiconductor or any other solid that does not react chemically with the film. Preferably, the film is formed on the surface of gold or glass. The film may be prepared by techniques well known in the art, such as by melting. The film may also be prepared by dissolving the compound in a solvent, spraying the solution over the surface of the substrate and evaporating the solvent. To speed the evaporation process, the film may be heated, preferably to temperatures between 40 C and 70 C, except for the polyurethane compound which is preferably heated near 80 C so that it is well above its melting point of 62 C. Note that if the film is formed by sputtering or spraying, the activation process may be enhanced by ionizing the droplets as they are deposited.

If the initial compound chosen was one of the hydrocarbons, then the activation step may include a thermooxidation of the film in order to introduce oxygen-containing polar groups. The film is heated in air at a temperature of 100 C to 110 C for 1-2 hours. The exact duration of the heating may be controlled by monitoring the IR-spectrum and static dielectric constant of the film until they indicate the presence of carbonyl groups. When the content of oxygen reaches at least 0.1 atomic percent and the static dielectric constant reaches at least 2.4, the thermooxidation is complete.

In this embodiment, the activation of the film includes the ionization of the adsorbed macromolecules, e.g., by ionizing radiation or chemical ionization. For example, the ionization may be performed by exposing the film to UV radiation. Specifically, a 120 Watt mercury lamp having a 5 cm tube at a working pressure of 0.2-0.3 MPa may be positioned about 5 cm from the film. Any other method of exposing the film to similar UV radiation, however, may also be used. A typical exposure time under the above conditions is 1.0-1.5 hours, except for the silicon-oxygen polymers which are typically exposed for 4-6 hours. The exact duration of exposure can be controlled by monitoring the magnetic properties of the film. From an analysis of the form and intensity of the dependence of the magnetic moment on the applied external magnetic field, one can determine the concentration of stable free electrons in the film. When the concentration of free electrons is at least 3×10¹⁷ electrons/cm³, or possibly higher depending on the specific process, then the UV irradiation is complete. It should be noted that overexposure to UV radiation can begin to break the main chains of the macromolecules.

To enhance the diffusion of the ionized macromolecules and free electrons during the activation step, the medium may be subjected to agitation or vibration. For example, ultrasound may be applied steadily at 1 W/cm² or in pulses of higher intensity. The diffusion may also be enhanced by heating the medium or adding a solvent to the medium to reduce its viscosity.

Dopants

According to another embodiment, the medium is activated by adding one or more types of dopant. The dopants alter the properties of the medium by directly or indirectly enhancing the production of free electrons in the medium. Dopants may be, for example, electrons, ions, elements or compounds that ionize at a low energy level, or that enable the ionization of other materials.

One class of dopants has been described by one of the present inventors in WIPO publication WO 02/080194 A2 ( 10 Oct. 2002) entitled CONDUCTIVE POLYMER MATERIALS AND METHODS FOR THEIR MANUFACTURE AND USE, as well as in U.S. Pat. No. 6,563,132, both of which are hereby incorporated by reference. This class of dopants includes certain neutral compounds having low ionization potentials, as summarized in Tables I, II and III below.

TABLE I
Elements and Their Ionization Potentials

| Element | Li | Na | K | Rb | Cs | Sr | Ba |
|---|---|---|---|---|---|---|---|
| Ionization | 5.4 | 5.14 | 4.34 | 4.18 | 3.89 | 5.69 | 5.21 |
| potential (eV) | | | | | | | |
| Element | Al | Ga | In | Ce | Pr | Nd | Pm |
| Ionization | 5.98 | 6.0 | 5.79 | 5.47 | 5.42 | 5.49 | 5.55 |
| potential (eV) | | | | | | | |
| Element | Sm | Eu | Tb | Dy | Ho | Er | Lu |
| Ionization | 5.63 | 5.66 | 5.85 | 5.93 | 6.02 | 6.1 | 5.43 |
| potential (eV) | | | | | | | |

TABLE II
Inorganic Molecules and Radicals

| Radical | VO | TaO | CeO | PrO | NdO | UO | UO.sub.2 |
|---|---|---|---|---|---|---|---|
| Ionization | 5.5 +/− 1.0 | 6.0 +/− 0.5 | 5.2 +/− 0.5 | 4.9 +/− 0.5 | 5.0 +/− 0.5 | 5.72 +/− .06 | 5.5 +/− 0.1 |
| potential | | | | | | | |
| (eV) | | | | | | | |
| Radical | CaOH | CaF | CaCl | SrO | SrOH | Sr.sub.2O | SrF |
| Ionization | 5.9 +/− 0.1 | 6.0 +/− 0.5 | 6.0 +/− 0.1 | 6.1 +/− 0.5 | 5.55 +/− 0.1 | 4.8 +/− 0.5 | 4.9 +/− 0.5 |
| potential | | | | | | | |
| (eV) | | | | | | | |
| Molecule | | | | | | | |
| or radical | MoO.sub.3 | BaO | BaOH | BaF | BaCl | Li.sub.2 | Cs.sub.2 O |
| Ionization | 6.2 +/− 1.0 | 6.5 +/− 0.3 | 4.5 +/− 1.0 | 4.9 +/− 0.3 | 5.0 +/− 0.1 | 6.8 +/− 0.2 | 4.45 +/− .06 |
| potential | | | | | | | |
| (eV) | | | | | | | |

TABLE III
Organic and Element-Organic Compounds

| | | | | | |
|---|---|---|---|---|---|
| Molecule | (CH₃)₃CH | N,N,N′,N′-Thetramethyl- | (C₅H₅)₂Ni | (C₅H₅)₂Cr | C(CH₃)Fe(CO)₃ |
| or radical | | n-phenylendiamin | | | |
| Ionization | 6.93 +/− 0.05 | 6.18 +/− 0.03 | 6.2 +/− 0.1 | 5.5 +/− 0.05 | 6.42 +/− 0.05 |
| potential | | | | | |
| (eV) | | | | | |

An associated class of neutral dopants can be described generally as the 3d and 4f transition metals. The 3d transition metals are Ti, V, Cr, Mn, Fe, Co, Ni, and Cu. The 4f metals comprise La, Ce, Nd, Pm, Sm, Eu, Gd, Tb, Dy, Ho, Er, Tm, Yb, and Lu., commonly called the Lanthanides. Many of the Lanthanides have a low ionization potential and some are included in Table I above. In addition the dopants of this class may also chemically interact with the medium, producing free electrons. The multivalence of most of the transition metals cited provides for contribution of such free electron without causing charge imbalance. In addition, the highly localized nature of the 3d and 4f ligands further facilitates formation of polarons within the macromolecular medium.

These metal dopants may be introduced into the macromolecular medium in the form of a soluble organic salt dissolved in a solvent. For example, from the 4f group Cerium Oxalate Nonahydrate (available from Aldrich, Cat # 32,551-1) or Lanthanum(III) acetylacetonate (available from Aldrich, Cat #32,575-9) may be used. Also, Neodymium (III) acetate hydrate (available from Aldrich, Cat-32,580-5). Most other 3d and 4f transition metal organic salts are soluble in toluene and could be used as well. It is preferred to use soluble organic salts in which the lowest valence of the transition metals are used to allow “donation” of free electrons to the system as the valence state is increased by either oxidation or the influence of external ionization processes such as UV illumination.

An excellent candidate would be Manganese II 2,4-Pentanedionate; it is soluble in ethanol (and thus will not dissolve too much of the film) and it oxidizes to the trivalent state readily, contributing an electron to fibrils. This compound can be acquired from Gelest, Inc., 612 William Leigh Drive, Tullytown, Pa. 19007. Most other 3d and 4f organic salts are soluble in toluene and could be used as well.

The ions in the macromolecular medium that electrostatically balance the free electrons may be either ionized macromolecules, or other ions of lower molecular weight, which are then considered another class of dopants. In other words, some dopants may catalyze the production of free electrons, and other dopants may donate a free electron and remain as an ion. There may also be other chemical combinations such as the dopant ion bonding with a macromolecule.

Another type of dopant is termed a charged dopant. In contrast to the neutral dopants described above, these dopants are already charged when they are introduced to the macromolecular medium. Charged dopants may include, for example, electrons and ion additives. The introduction of these charged dopants can enhance the formation of threads, for example, by directly inserting additional electrons, or by drawing electrons from a conductive substrate in contact with the medium. A very small density of ions is typically adequate, e.g., about 1 ppm by weight, but generally a higher density may be better in many cases, e.g., up to 1 weight %. The density is often self limiting based on the electric field generated by the charge density.

These charged dopants are introduced into the macromolecular medium using one or more of various techniques. In one embodiment, an electrolysis activation technique may be used as part of a method of producing a polymer material. For example, FIG. 18 shows an apparatus for implanting dopants using electrolysis, according to one embodiment of the invention. This apparatus was used in the following procedure for producing a material with a free electron concentration of ˜10¹⁸ cm⁻³. First, an atactic polypropylene was used to prepare a 5-micron thick polymer film 130 on a copper substrate 132. The substrate and film were about 2 cm×2 cm, and the film was deposited from a 2% solution of the polymer in toluene. Second, the film was oxidized in air for a 1 hour at 100 C. Third, ˜0.1 cm³ of 0.1 mass % sodium chloride water solution 134 was placed on the surface of the polymer film 130. Low conductivity distilled water was used for the preparation of this solution. Fourth, a small copper probe 136 was inserted into the drop of sodium chloride solution 134; the probe didn't touch the surface of the sample 130. Then 10 volts DC was applied through a current limiting resistor 138 of 10 kOhm, between the copper substrate 132 and the probe 136. The positive voltage was applied to the probe, and minus to the substrate, from a power supply 140. An average current of 1 microampere was flowing through the sample for 6 hours. Fifth, the sample was UV irradiated with a 125 watt mercury high-pressure lamp (not shown) for a 1 hour. Then the sample was maintained in the air at room temperature for a week. In this example, the salt water formed a liquid electrolyte containing sodium ions, such as ion 142. These ions are implanted into medium 130 during the electrolysis process, resulting in implanted ions, such as implanted ion dopant 144. After recombination with electrons from the substrate 132, these ion dopants become neutral dopants, such as dopant 146.

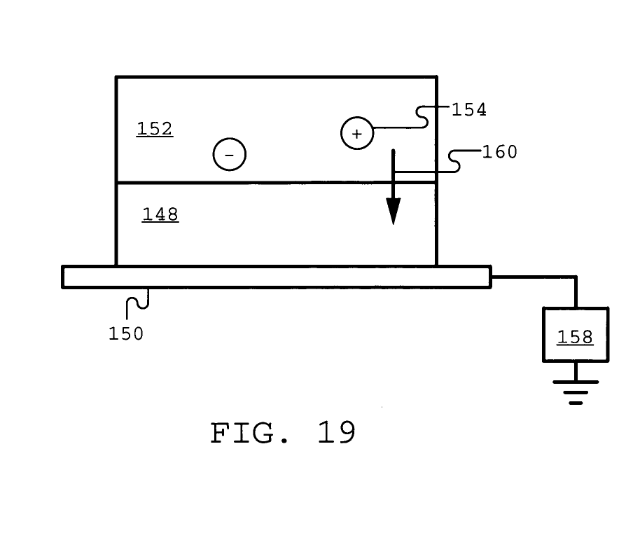

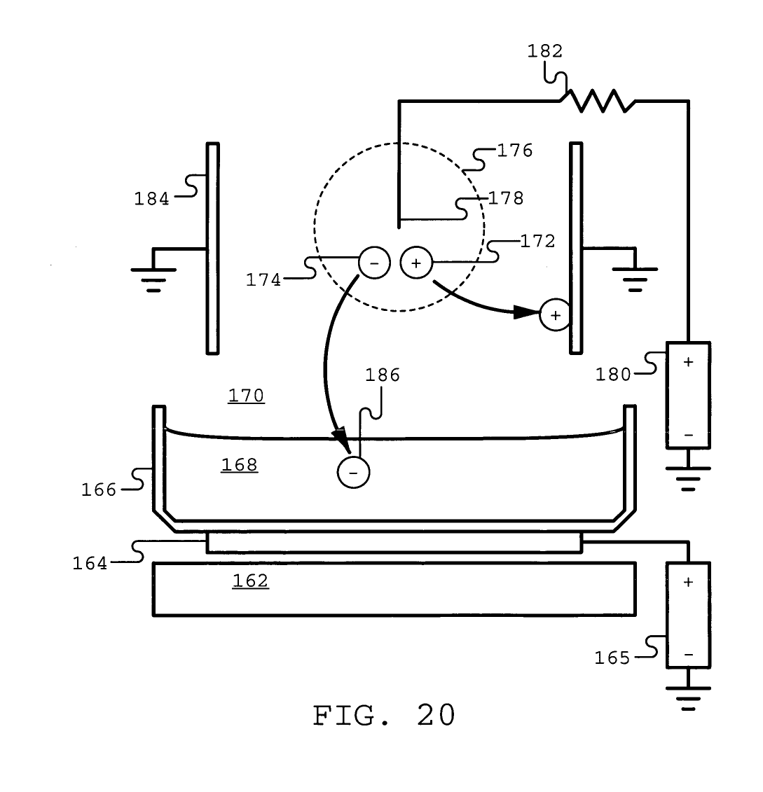

Other electrolytes may also be used including gels and pastes in contact with the macromolecular material. For example, FIG. 19 shows an apparatus for implanting dopants using electrolysis, according to another embodiment of the invention. A macromolecular medium 148 is deposited upon a substrate 150. An electrolyte paste or gel 152 in contact with the medium 148 comprises positive ions 154 and negative ions 156. A voltage source 158 creates a potential that induces movement 160 of ions into the medium 148.

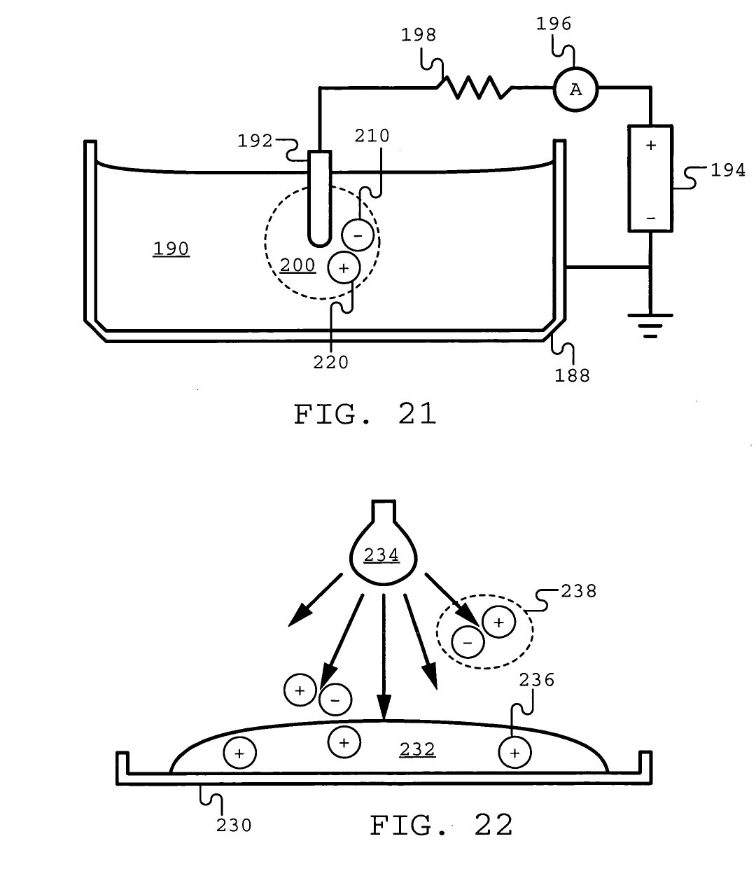

According to another technique, ions are implanted in the macromolecular material or medium from an ionic plasma. For example, FIG. 20 shows an apparatus for implanting ions from a plasma, according to one embodiment of the invention. An electrical insulator 162 supports a positive electrode 164 connected to a power supply 165. The electrode 165, in turn, is positioned beneath a container 166 within which is placed a quantity of macromolecular medium 168. Above the surface of the medium 168 is air or other gas 170. A portion of this gas about 3-30 cm above the surface is ionized to form a plasma comprising positive ions 172 and negative ions 174. Such a plasma may be created, for example, by generating a high intensity electric field in a region 176 around an electrode tip 178 formed of a 1 mm diameter wire. The field at the tip of the wire is about 40 kilovolts/cm, which is sufficient to ionize the air. This field is local to the wires to reduce the possibility of sparks. The electrode 178 is connected to a power supply 180 via a current limiting resistor 182. Grounded plates 184 attract the positive ions 172 and repel the negative ions 174. The positive voltage applied to the electrode 164 then draws the negative ions into the material 168, producing implanted ions 186. Reversing the sign of the substrate voltage reverses the sign of the ions that are implanted. Alternating the sign at about 1.0-0.01 Hz keeps the overall electric charge of the material 168 neutral, enabling a larger number of ions to be embedded.

According to another technique for ionizing the medium, a low viscosity polymer solution of the macromolecular medium is sprayed or dropped onto a substrate or container, during which the individual drops may be ionized. For example, in one embodiment, the drops are ionized as they leave a spray gun. The ions are naturally embedded in the polymer material as it forms from the collected drops. The ionization can be triboelectric, due to the drops rubbing on some material, or it may be cause by a high electric voltage being applied in the pathway of the drops. Electro-spraying is used in painting, and the method may be applied here, using the macromolecular material in solution in place of paint. Caution is required since solvents are often flammable, and it may be advisable to do electrospraying in an inert gas such as nitrogen. For example, the spray nozzle may be at a negative potential to create negatively charged drops, and the substrate at a positive potential to attract the drops.

Various techniques for activating the medium include directly introducing electrons into the medium as a specific type of charged dopant. For example, electrons may be distributed on the surface of the medium, and made to diffuse into the medium, such as under the influence of an electric field. The field can be created by applying a voltage to the substrate, if the substrate is a conductor, or by placing the substrate on a conducting plate which is at a voltage. For example a voltage of about 10 volts may be used for a film 10 microns thick, and a voltage of about 200 volts for a film 100 microns thick. If the film is flooded with electrons, the amount of charge that will attach to the material will be related to the capacitance of the configuration and the voltage, according to the well-known relation Q═CV. The electrons may also impinge on the medium with some velocity, which causes penetration into the medium. The electrons, like the ions, will act as a catalyst for the production of ion-electron pairs. The electron additives, being negative charge, not balanced by a corresponding ion, will build up to a certain potential, which will then tend to repel further charging. However, the additives can instigate a large number of ion-electron pairs, which do not add to the overall charge. Thus, the total number of free electrons created is not restricted by the number of electron additives. This is like a chain reaction since when an electron enables a new pair, there is always an electron left over to enable the next reaction.

FIG. 21 shows an apparatus for activating a macromolecular medium using a high voltage microtip, according to one embodiment of the invention. A grounded copper container 188 contains a macromolecular medium 190. Inserted into the medium is a moveable electrode 192 having a microtip of radius of curvature less than 1 micron, e.g., 100 nm. The electrode 192 is connected to a 0-100 V variable power supply 194 via a microammeter 196 and a 100 kOhm current limiting resistor 198. The voltage is increased until a current of 100 nanoamps flows. At 100 V, the small microtip of electrode 192 creates an intense field of 1000 kV/cm in a region 200 of 1 micron radius around the tip, resulting in the creation of free electrons 210 and corresponding positive ions 220.

In another example, additive electrons are generated by hot or cold cathodes, such as using field emission from an array of microtips conventionally used in displays. Another source of electrons is a scanning electron microscope (SEM). The “environmental SEM” (ESEM) is suitable because it can scan a sample in air. In some cases, however, it may be beneficial for the electrons to be added in a vacuum. The vacuum may be partial and may include the purging of air and the addition of specific gases to control any ionization which may accompany the deposition of the electron additives.

It may be desirable for some applications that the conductive structures and free electrons form a predetermined pattern in the material, rather than being generated homogeneously or with random distributions. Thus, some embodiments of the invention include techniques for controlling the distribution pattern. According to one embodiment, an electron beam is controlled in position and intensity, similar to the operation of a cathode ray tube or a scanning electron microscope. Such a device then creates a pattern of additive electrons in the macromolecular medium, and the conductive structures will follow this same pattern. Another approach is to use a laser to create a pattern of free electrons. A laser is another means of inducing free electrons, preferably with UV or higher energy photons, and also by stimulating the material with two-photon ionization at lower photon energies. The laser can also be scanned in a pattern, for example, using moveable mirrors. By splitting the beam into two beams, the intersection of these two beams can create a pattern of points. One example of a pattern is a collection of closed loops, which is useful in some techniques for creating diamagnetic materials. The pattern may be formed using a laser or electron gun. The activated material with these loop patterns can be used as part of processes for producing diamagnetic macromolecular materials containing highly conductive loop threads.

Contact Charging

According to another aspect of the invention, the activation of the macromolecular medium is facilitated in part by electrically charging a second material in contact with the medium. Typically this secondary material is a substrate upon which the medium is deposited, as will be described below. However, similar principles and techniques may be used as well for other types of materials in contact with the macromolecular material such as, for example, the inside of a container, or the outside of a probe inserted in the material. Thus, the discussion of substrate charging below is intended to be generally applicable to these various types of secondary materials other than just substrates.

Charging a substrate in contact with the medium can be beneficial for various purposes, but it is particularly beneficial as part of various activation techniques, such as during exposure of the material to UV light or laser light, as discussed above. The charge applied to the substrate may be positive or negative, and in the case of a dielectric substrate such as glass, there may be both positive and negative charges on the substrate either in different areas or interspersed. Where the substrate is conductive the charge will be more evenly distributed, but the electric field will be more intense at points and sharp edges-the normal scratches and asperities at the microscopic level on a conductor.

FIG. 22 illustrates one technique for charging a macromolecular medium using a dielectric substrate according to one embodiment of the invention. The figure shows a dielectric 230, which may be, for example, a glass dish, covered with macromolecular material 232 irradiated by a UV lamp 234, possibly a mercury lamp. The substrate is charged in this example with positive charges 236. Note that these charges could be positive ions from another source, or could be ions in the glass where electrons have been removed. in the figure, the radiation is shown ionizing the gas, normally air, resulting in positive and negative charge pairs 238. The negative ions are drawn toward the positive potential on the substrate, causing them to impinge on the material.

FIG. 23 illustrates one technique for charging a macromolecular medium using a conductive substrate according to another embodiment of the invention. The figure shows a conducting metal substrate 240, covered with macromolecular material 242 irradiated by a UV lamp 244, possibly a mercury lamp. The charge on the metal substrate is not shown since it is distributed. The substrate is charged in this example with electrons which create very high fields at the asperities 246 of the conductor 240. The radiation is shown ionizing the gas, normally air, and the resulting positive ions 248 being drawn toward the substrate under the influence of a negative potential placed on the substrate by a high voltage power supply 250. The ions impinge on the material 242 and facilitate its activation.

In the two cases just illustrated above, the electric field is significantly large on average. For example, if the substrate surface potential is 10,000 volts and the nearest grounded points are 1 cm away, there will be an electric field of at least 10,000 volts per cm.

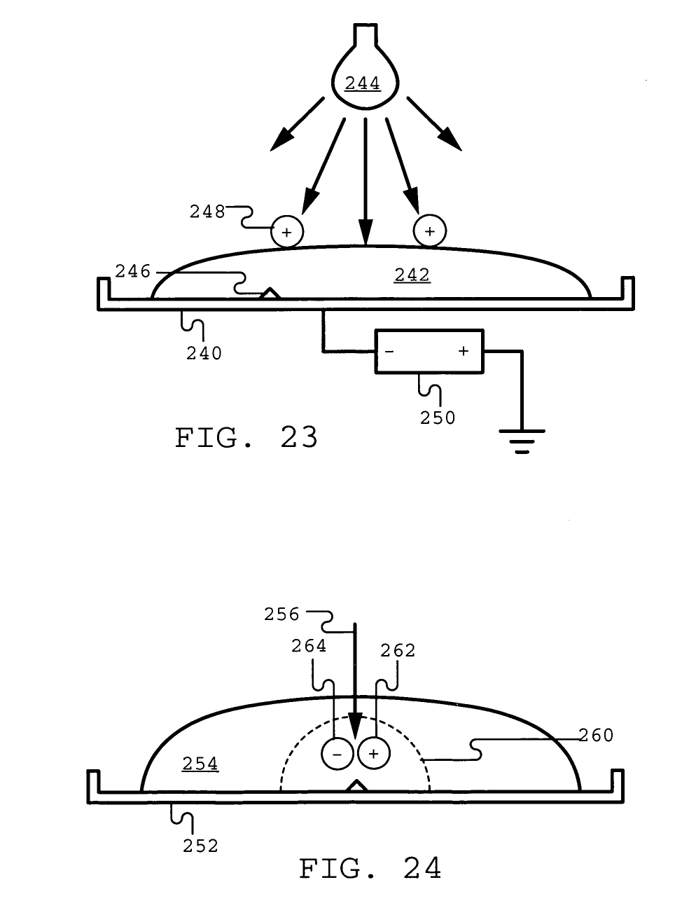

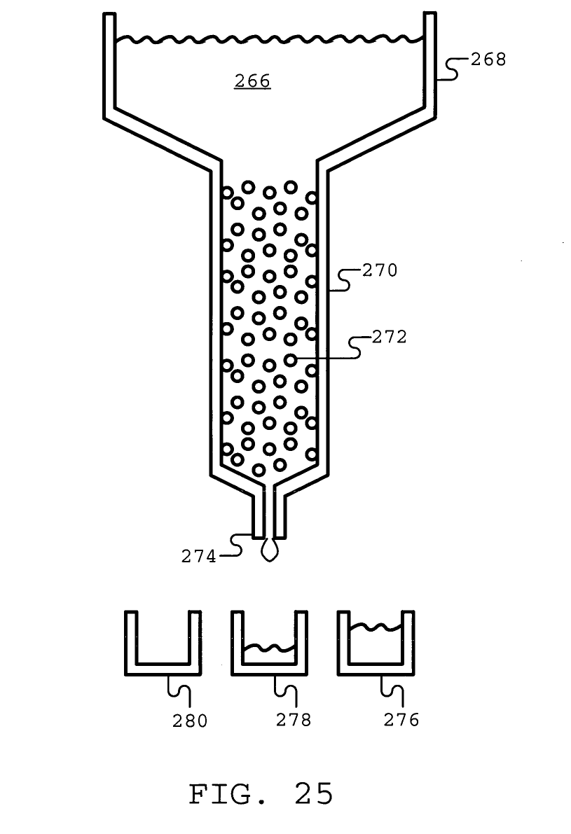

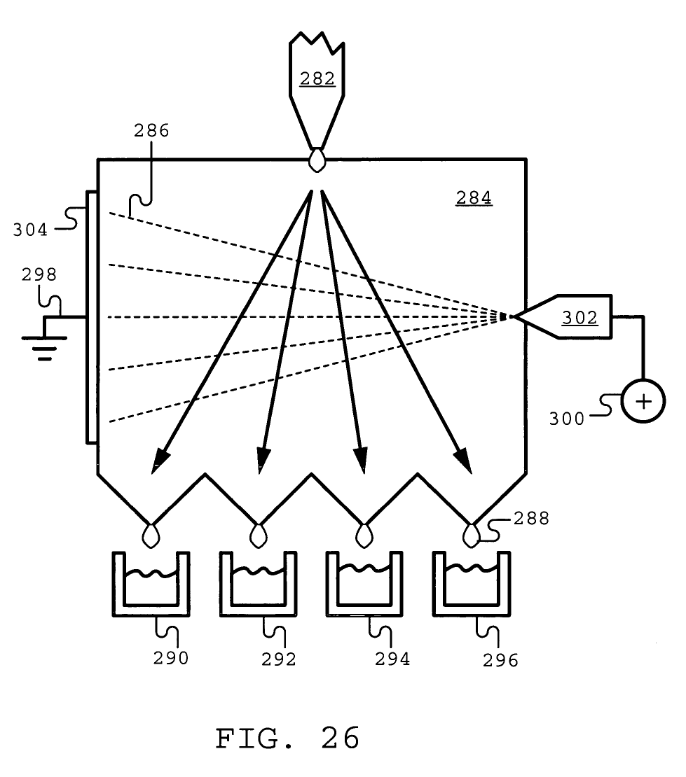

However, in the immediate vicinity of individual ions (on a dielectric) or asperities (on a conductor) the field can be many times greater. A well known example of this is a field emission microtip, which is able to emit electrons with just a few volts because the tip has a sub-micron radius of curvature, and the field is inversely proportional to tip radius. Arrays of such microtips are used for display products, and such an array would make an excellent substrate, enhancing the effect of the charge. The macromolecular material in these high field areas can locally ionize if the field is high enough, or at least have its ionization energy reduced by the high field. With reduced ionization energy the typical UV photon can ionize the atom or molecule. As in the case of electron or ion additives, the original charge induces the ionization, which leads to an ion-electron pair, the electron of which becomes a free electron. As these solvated entities diffuse away, the original charge will then be available to repeat the process. For example, FIG. 24 illustrates aspects of an activation technique according to an embodiment of the invention. A charged substrate 252 has a macromolecular material 254 in contact with it. The material 254 is exposed to UV radiation 256, causing in ionization near a region of high field intensity 260 in the immediate vicinity of an ion or asperity. An ion 262 and solvated free electron 264 are produced.

There are many methods for charging the substrate. For example, if it is a conductor it can be charged from any high voltage source such as a Tesla coil or a Wimshurst machine, or by any method used for a dielectric substrate. A conductor can be insulated from its surroundings, and hold a charge like a dielectric. For such a conductor it is possible to add a capacitor which will hold more charge, and ensure that the potential does not decay as quickly due to leakage when the substrate is disconnected from the voltage source. It is often convenient, and/or safer in manufacturing, not to have a voltage source in the vicinity of flammable solvents.

Dielectric substrates may be charged by various techniques as well. For example, they can be charged by exposure to a source of positive or negative ions, and can have both positive and negative ions simultaneously on the surface. There are several types of ion generators such as high voltage ionizers used for air purification. Placing a high voltage plate behind the substrate will attract ions with the opposite charge to the surface of the substrate.

Similarly, a source of electrons can be used for charging, such as an SEM, or a cold cathode. To charge a dielectric it is possible to cover it with another charged material and press them into intimate contact. When the material is removed there will be remaining charge on the substrate.

Triboelectric charging of the substrate is yet another approach. It can be accomplished, for example, by placing a material in intimate contact with the substrate, where the material and the substrate are far apart on the triboelectric index. Rubbing usually enhances the intimate contact. For example, if the substrate is Pyrex glass and it is rubbed with dry paper the glass will acquire a positive charge. However, if the glass is rubbed with paper soaked in toluene, the glass acquires a negative charge. High charges can be created inadvertently in a dry environment and thus may have to be controlled in circumstances where electrostatic discharge (ESD) is a problem.

The charge on a dielectric substrate can also be enhanced by backing the substrate with a conductor which is itself charged. In this case a thin dielectric is desirable, or a thin dielectric coating on the conductor.

Enrichment Techniques, Creating Fibrils and Threads

The inventors have discovered that the free electrons created in the macromolecular medium during activation can combine to form stable multielectron structures called fibrils, as well as longer conductive threads composed of multiple fibrils. These collective multielectron structures can be detected by monitoring the ferromagnetic susceptibility of the macromolecular medium. The ferromagnetic saturation appears to occur at 0.5-5.0 kGauss at room temperature. The time needed to reach ferromagnetic saturation can be made shorter by certain techniques such as heating the substance, introducing a solvent, or exposing it to microwave radiation. Microwave power levels may range from 100 W to 10 kW, where the higher power levels are pulsed to avoid overheating the substance.

The inventors have discovered that higher fibril concentrations facilitate the generation of conductive threads in the medium. A concentration of at least 10⁸-10⁹ fibrils/cm³, for example, is sufficient in many cases. Accordingly, in order to obtain sufficient concentration levels, the medium is preferably subjected to one or more enrichment techniques that increase the concentration of fibrils and/or threads in a macromolecular medium. Most approaches to enrichment are based on separating the conductive threads from the bulk of the macromolecular medium. This results in a medium with a higher concentration of conductive structures, which can benefit the production of certain products such a long conductors and diamagnetic material with a good yield (i.e., at least 1%, preferably 10%, and most preferably 50% or more). Hence enrichment is useful for many commercial products using highly conductive threads. Several methods of enrichment are described below.

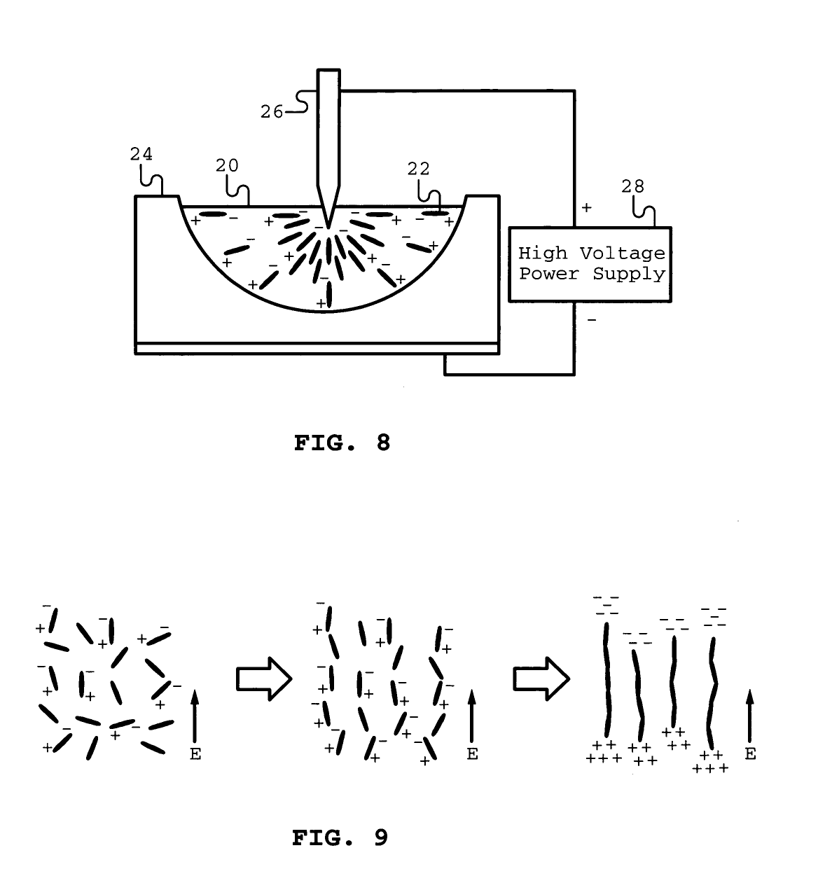

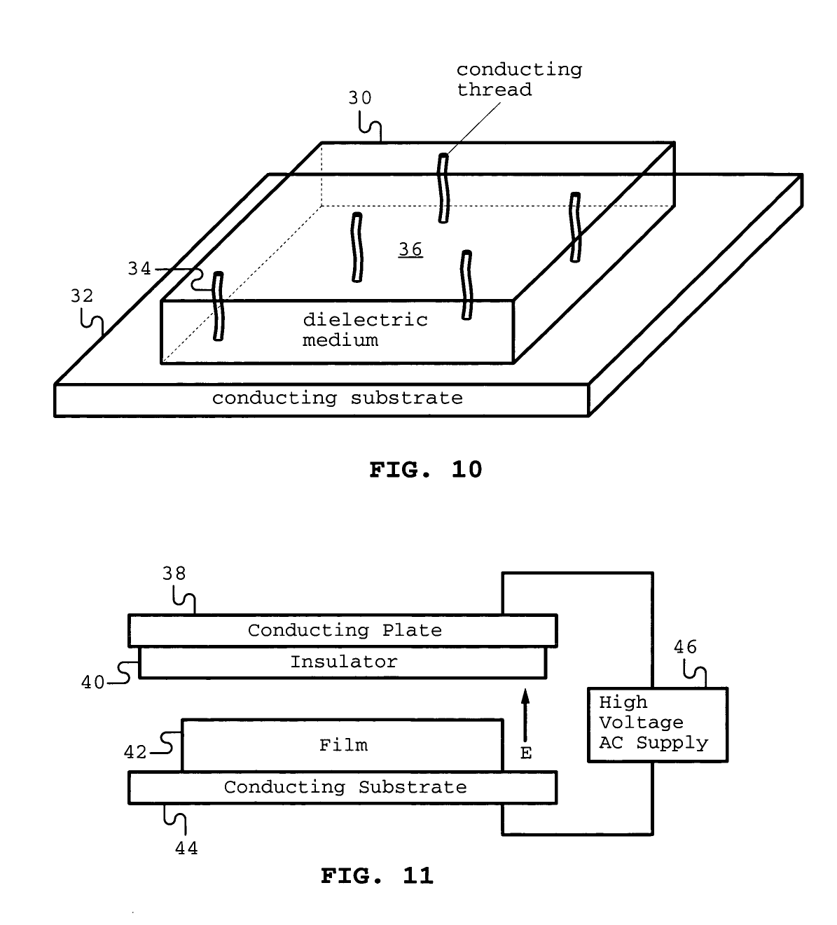

One illustrative example of such an enrichment technique is shown in FIG. 8. A viscous medium 20 containing fibrils 22 is placed in a small cup 24 made of an appropriate dielectric material. The preferred diameter of the cup is 5-6 mm, although other diameters are possible. A sharp tip of an electrode 26 is placed in the medium near the center of the top surface and a high voltage is applied through a high voltage power supply 28. For example, a voltage of 5-10 kV may be applied for several hours. Many fibrils and/or threads are naturally drawn toward the electrode tip and concentrated there. The enriched medium in the vicinity of the tip is then collected. This technique can be performed with multiple electrodes if desired. It should also be noted that this procedure can be performed analogously by the application of a magnetic field instead of an electric field.

One object of the enrichment process is to produce a medium with a larger density of threads, each of which has many free electrons associated with it. An enriched material is typically required to produce useful conductors. In practice, most enriched materials will have densities of 10¹⁹ to 10²⁰ free electrons per cubic centimeter, or possibly more.

Viscosity Reduction

The reduction of viscosity of the macromolecular medium is beneficial for creating enriched material. The enriched material in turn, is useful for making diamagnetic material, thicker films, and longer conductors. Because a low viscosity might naturally be expected to destabilize the fibrils and free electrons, however, it was not known before the present invention whether significantly lowering the viscosity would be a useful technique. Moreover, even supposing it were useful, it was not known by what means and under exactly what conditions the viscosity can be usefully lowered. After considerable experimentation and discovery, however, the inventors have developed useful techniques for reducing the viscosity of the material without significantly degrading the number of fibrils present.

Two methods of reducing the viscosity of the macromolecular medium are heating the medium and adding one or more solvents to the medium. Heating the macromolecular material above the vicinity of its glass transition temperature usually produces a rapidly declining viscosity. The temperature to which the medium is heated is naturally below that at which the polymer starts to disintegrate. It has been found experimentally that most (or at least 50%) of the conductive threads usually survive in heat up to the vicinity of 100 C for a few hours, depending on the macromolecular medium. For example, a method for reducing the viscosity of a macromolecular medium containing highly conductive structures for a period of time, while preserving most of the conductive structures, includes heating the medium for a few hours, preferably 2 to 4 hours, such that the viscosity is reduced to about 100 N.s/m² or less. In another example, it is heated until the viscosity is reduced to about 0.1 N.s/m² or less.

Another method of viscosity reduction, adding a solvent, has the advantage of lowering viscosity at room temperature. It is often more convenient to process the medium at room temperature and in many cases the medium will dissolve in a suitable solvent in 15-30 minutes. For example, atactic polypropylene containing free electrons can dissolve and become a 1% solution in Toluene. Hexane and Heptane are examples of other solvents that may be used. In the context of the description of this method, the word “dissolve” is understood to mean the dissolving of the polymer molecules of the medium that are not directly associated with the fibrils or conductive threads. This solution may be thought of as a meta-stable suspension of fibrils in the polymer solution. A viscous macromolecular medium can be recovered by evaporation of the solvent, using the conventional heating or vacuum techniques. This process retains most (or at least 50%) of the conductive threads, according to measurements of the magnetic signature using a magnetic balance. In Toluene, the free electrons were only slightly reduced in 4 hours, but were significantly reduced in 5 hours. Hence there is a period of about 1 to 3 hours in which enrichment methods, such as filtration, may be practiced effectively using a low viscosity medium. In the case of filtration, the filtered medium, or its retentate, can be recovered without significant loss of free electrons.

Another example of a method for reducing the viscosity of a macromolecular medium containing highly conductive structures for a period of time, while preserving most of the conductive structures, includes adding a solvent to the medium, such as by mixing the medium in the solvent for 15 minutes to 30 minutes, and maintaining this solution or gel for a few hours, preferably less than 3 hours. The medium or the material can then be recovered by evaporating the solvent. The viscosity is preferably reduced to a viscous gel, with viscosity about 100 N.s/m² or less, or for methods such as filtering to about 0.1 N.s/m² or less. The viscous gel is used where the lower viscosity enables the movement of threads, but the viscosity is still high enough to minimize thermal convection currents in the medium which could be disruptive to the fragile threads. With no convection current they are less likely to break, and if they do break there is a likelihood that the ends will join again under the force of the electric fields, but only if they are still in proximity.

Fractionation

According to another aspect of the invention, various methods of fractionation, which separate different molecular weights and particle sizes within a macromolecular mixture, are used to facilitate enrichment and increase yield in the production of highly conductive materials. The conductive threads typically are associated with dozens or hundreds (or more) of molecules, self assembled, and hence may be separated by fractionation techniques from the single molecules not associated with the conductive thread. Furthermore, these structures act like particles suspended in the low viscosity medium, allowing for improved harvesting. These fractionation techniques include methods such as high performance liquid chromatography (HPLC), size exclusion chromatography (SEC), disc centrifuge photodensitometer (DPC), capillary hydrodynamic fractionation (CHDF), field flow fractionation (FFF) and other similar techniques. Other techniques may also be used that are based on various adsorption, deabsorption, and/or diffusion mechanisms.

These fractionation methods are typically implemented with a low viscosity medium. Some of the equipment for fractionation, for example, uses a flowing solvent into which the substance to be fractionated is injected. Thus, according to one embodiment, to increase a concentration of free electrons in a macromolecular material, the low viscosity macromolecular material is injected into the solvent flow, flowing then along the surface of the active solid; and collecting in a beaker a portion of material from the solvent flow after interaction with the active solid at a specific moment of time. The collection time is derived from the different flow rates of the material with conductive structures and that without it. The timing may be calibrated by a number of experiments, where the output for all time periods is compared in the magnetic balance. Once the calibration is made, the magnetic balance does not have to be used, making the process much more efficient since the magnetic balance is a very time consuming measurement. The collected portion is then processed to remove the solvent, such as by heating or vacuum, to obtain an enriched material having a concentration of free electrons greater than an original concentration of free electrons in the macromolecular material.

FIG. 25 is an apparatus illustrating another enrichment method employing fractionation according to an embodiment of the present invention. In the figure, a low viscosity medium 266 containing conductive structures is poured into a container 268 at the top of a packed column 270. The medium 266 flows through the column 270 under the influence of gravity and passes through packing material 272, such as absorbent particles. As the medium passes through the column it is divided into a number or fractions, for example each fraction could be one tenth of the original amount of the medium. As the medium emerges from an opening 274 at the bottom of the column, it is collected sequentially into separate containers. In the figure, container 276 is shown full, container 278 is filling, and container 280 is waiting to be filled. Because the different fractions pass through the column at different rates, the containers will have different concentrations of free electrons. These separated fractions in the various containers are then measured to quantify the density of free electrons, and the ones with the highest density, for example the top 10%, are retained as enriched material. The measurement could be in a magnetic balance to measure ferromagnetic strength, or it may be possible to use particle detection techniques, using light if the medium is transparent. The column packing material may be a silica based adsorbents, with a particle size from 3 microns to 10 microns.

The above example describes a method wherein the medium is flowing, wherein the flow is due to pressure, in this case the pressure is created by gravity, but the differential pressure could be from a positive pressure source such as a pump, or by drawing a vacuum to pull the medium past the absorbent material. It is also possible to use electromagnetic fields or other methods to create the flow of the medium.

Electrophoresis

Another separation technique that can be used for enrichment is electrophoresis. According to one embodiment of an enrichment method employing electrophoresis, the rate of movement of the conductive threads in an electric field, for example created by a voltage of 20 V to 100 V, will be different from that of non-conductive molecular medium, both because of differences in particle sizes, and because of the induced dipole in the conductive thread. This method is enhanced by the use of a reduced viscosity medium. In a typical electrophoresis apparatus the medium flows or diffuses across or along an electrophoresis gel available from supply houses such as Fisher Scientific. After separation in the apparatus, the portion containing the concentrated conductive threads is collected.

Dielectrophoresis

This is a type of electrophoresis which specifically uses a non-uniform electric field to attract electric dipoles. In a conductor the electric dipole is induced by the electric field, hence this is applicable to conductive threads. An example of this technique is described above in relation to FIG. 8. In that example, as in other variations on this technique, reduced viscosity is typically desirable for speeding up the process. However, heating may not be convenient, or may be counter-indicated by other factors. Hence the addition of a solvent to improve the speed and the yield of the technique is beneficial. Thus, according to one embodiment, a method for enrichment includes adding a solvent to the macromolecular medium to form a lower viscosity medium. The solution (which may be a gel) is then subjected to an electromagnetic field that increases the concentration of free electrons within a region of the solution. The enriched material is then collected from the region. In one illustrative example, the lower viscosity medium is about a 5% to 50% solution. The electromagnetic field is a cylindrically diverging electric field produced by 1000 V on a 1 mm diameter wire. The field is 20 kV/cm at the surface of the wire decreasing to 1 kV/cm at 1 cm from the axis of the wire. This non-uniform field will attract the conductive structures to the wire. The 10% nearest the wire could then be captured by various means, for example by having a hollow wire with holes uniformly spaced and drawing 10% out through the wire. FIG. 26 illustrates another approach to dielectrophoresis. A source of macromolecular medium dispenses the medium on the surface of a flat membrane 284, such as paper, and as the solution flows down the membrane it is subjected to a non-uniform electric field 286, splitting the solution into two or more streams that form drops 288 at the bottom of the membrane 284. Drops from each of the streams is collected in a corresponding container 290, 292, 294, or 296.

The stream at the high field end will generally have a higher concentration of threads, resulting in an enriched medium in container 296. The non-uniform electric field is produced by applying a potential difference between electrical contacts 298 and 300. Positive contact 300 is connected to a pointed electrode 302, while negative contact 298 is connected to a large electrode 304.

Powder Method

Another approach to enrichment is a solid state analog of dielectrophoresis. An electric or magnetic field, preferably non-uniform, is used to provide a high field gradient that separates the more conductive portions of medium from the less conductive portions. In this approach, however, the medium is in the form of a solid powder. Thus, for example, the material comprising conductive threads may be pulverized, e.g., by reducing its temperature below its glass temperature and grinding it to form a powder. Most, or at least 50%, of the threads are preserved since the powder grains are much larger than the average thread size. Some grains will contain more conductive threads than others. A strong electric and/or magnetic field may then be applied to separate the more-conductive from less-conductive particles. This can be done as a continuous process since the powder may flow and be separated into two or more streams by the fields, which would be beneficial for scale up and commercial production.

Filtering

Yet another method of enrichment is to filter the medium containing conductive threads. Filtering often starts with a liquid with low viscosity, which is typically obtained by adding a solvent. In some filtering, it is preferable to have at least 50 wt. % of the medium be solvent. As was discussed above, the conductive threads can survive in the dissolved medium for a time (at least several hours), which is sufficient to do filtering and recover the enriched medium by evaporation. The filter pore size will determine the size of the conductive thread that is retained. Hence the smallest conductive threads may flow through certain filters. This is not a complete loss, since the filtrate can be used again.

There are many approaches to filtering, including the use of gravity, vacuum pressure, positive pressure, and centrifuge. A suitable filter will withstand the pressure and be inert to the solvent, hence Teflon is a good material if it is available as a filter. Pores that are too large may let too many conductive structures through and pores that are too small tend to clog up quickly. It has been found that 0.1 microns, 0.2 microns and 0.5 microns are suitable pore sizes.

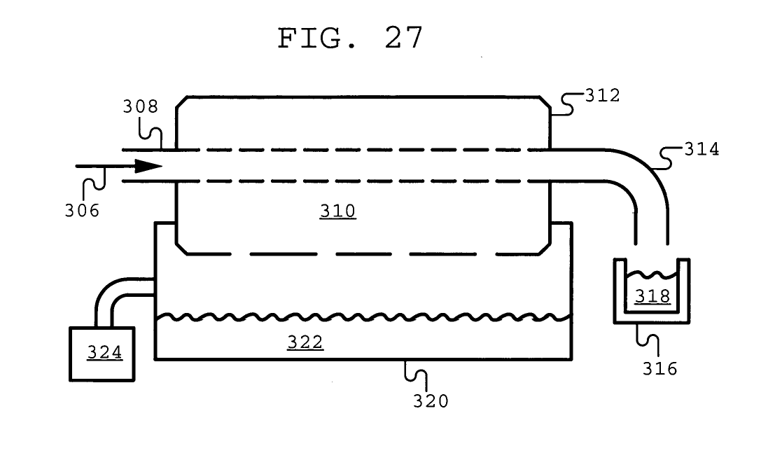

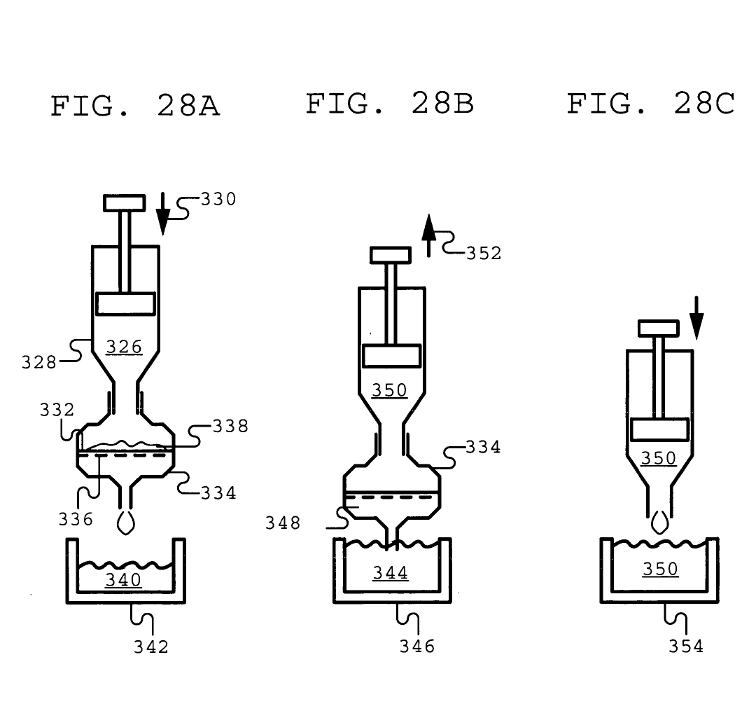

One method involves the use of a cross-flow filter, as shown in FIG. 27. An incoming fluid of macromolecular medium 306 comprising highly conductive threads flows into an inner tube casing 308 of the filter. The casing 308 is surrounded by a filtering material 310, preferably a fluorocarbon compound. A filtrate portion of the medium 306 passes through this filter material 310 while an enriched portion continues through the inner tube 308 and exits at a filter output 314 where an enriched medium 318 is collected in a container 316. A container 320 collects the filtrate 322 emerging from the filter material through holes in an outer tube casing 312. This filtrate has a reduced concentration of highly conductive threads. A vacuum pump 324 creates a pressure differential across the sides of the filter material 310 so that the filtrate will be drawn through the filter material during operation.

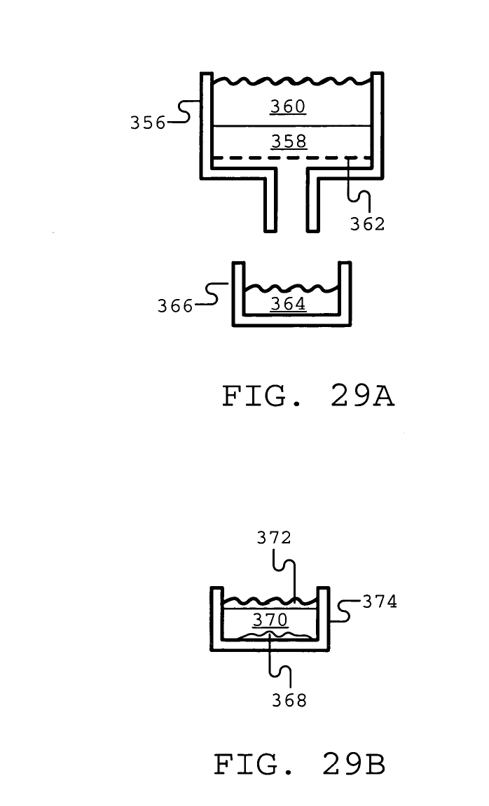

Another filtering technique is shown in FIG. 28A. This technique, suitable for small quantities, begins by placing a quantity of macromolecular medium 326 in a syringe 328. Hand pressure is used to move the syring plunger down 330, forcing the medium out of the syringe and through a filter material 332 contained in a filter housing 334 attached to the syringe. A support 336 within the housing 334 may be used to retain the filter 332 in place. A retentate 338 containing the enriched medium is collected on the filter surface while a filtrate 340 passes through the filter material and is collected in a container 342. The retentate 338 may be removed from the filter material 332 by various means such as scraping, ultrasound cleaning, or backflushing. If scraping is used, then enriched medium is dissolved once again, and the solution is processed in a timely manner, usually within one hour. Surprisingly, the inventors discovered that useful amounts of retentate could be recovered using this technique without destruction of a significant number of fibrils. Backflushing is illustrated in FIGS. 28B-C. After filtering the medium as described in relation to FIG. 28A, the opening of filter housing 334 is submerged in a clean solvent 344 held in container 346. A portion 348 of the fresh solvent 344 is then sucked up through the filter and into the syringe by pulling the syringe plunger in a direction 352 opposite to that shown in FIG. 28A. As the solvent passes up through the filter, enriched material collected on the filter is drawn up into the syringe reservoir with the fresh solvent, producing an enriched medium 350. As shown in FIG. 28C, the filter housing is removed from the syringe and the enriched medium 350 is ejected from the syringe into a container 354.

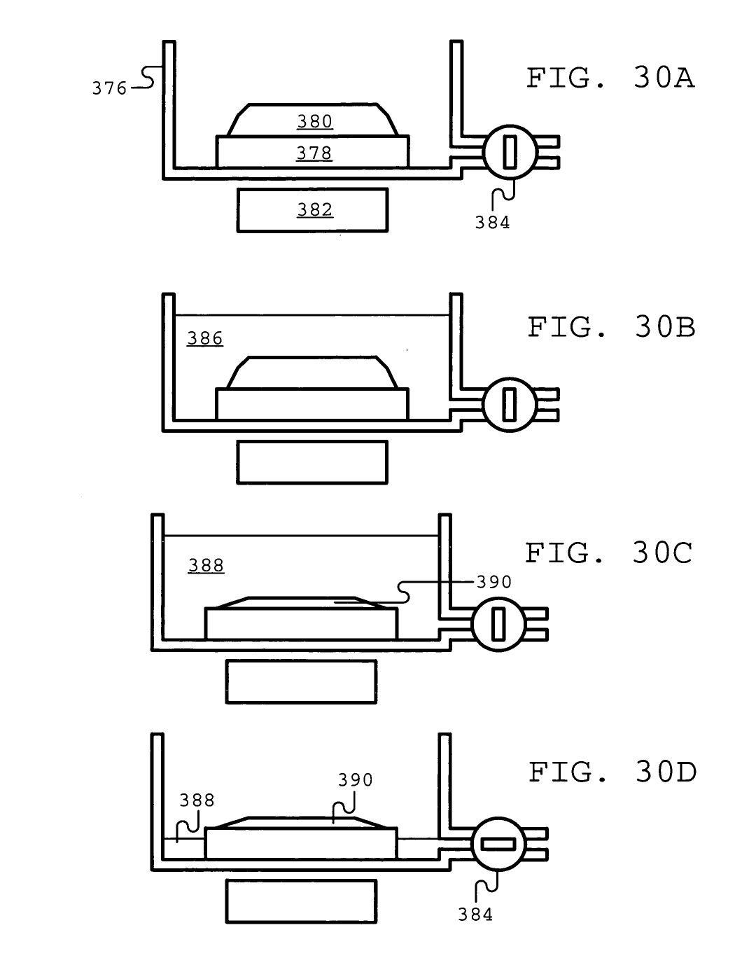

Another filtering technique uses a filter that can itself be dissolved after the macromolecular solution has passed through. FIGS. 29A-B illustrate the technique. A container 356 has within it a salt tablet 358 and a quantity of macromolecular solution 360 comprising threads, as shown in FIG. 29A. A grid 362 supports the tablet 358. The solution 360 enters the filter 358 and a filtrate 364 emerges and is collected in a container 366. Threads originally in the solution 360 remain as a retentate in the filter 358. An enriched material containing these threads is then recovered as shown in FIG. 29B. The filter 358 is placed in a container 374 and dissolving in water to produce a saltwater solution 370. Some of the salt may remain as undissolved salt 368 in the container. The enriched macromolecular medium 372 will be liberated from the dissolved filter and float to the surface of the water where it can be collected. Naturally, the solvent for the filter should not destroy the retentate. The filter may be composed of a compacted salt such as sodium chloride or potassium chloride. A sodium chloride filter, for example, may be compacted at about 6 atmospheres.

Separation Using Gravitational or Centrifugal Forces

According to another aspect of the invention, various techniques for separation and enrichment employ gravitational and/or centrifugal forces. When the macromolecular material with conductive structures is dissolved, the conductive structures are preserved for a period of time. The solvent can be chosen to increase the difference in density between the conductive structures and the solution, or to increase other differences. The application of gravitational and/or centrifugal force can exploit such differences to concentrate the conductive structures in one region which may then be extracted to produce an enriched medium.

One method for increasing a concentration of free electrons in a macromolecular material is to create a low viscosity medium, e.g., as low as about 0.1 N.s/m² or less, and use a centrifuge or similar technique to separate a portion, e.g., about a tenth, which has a high concentration of conductive threads. This portion of material is removed to obtain an enriched material having a concentration of free electrons greater than an original concentration of free electrons in the macromolecular material. The removal can be accomplished by freezing the medium after centrifuging, so the stratification is preserved when the vials are removed from the centrifuge. Another method is subjecting the macromolecular medium to gravity. Separation using gravity, however, normally takes much longer, e.g., maybe days. Thus, this technique is useful primarily when the fibrils have longer lifetime in the low viscosity medium. However it has the advantage of putting less stress on the conductive structures, and if the medium separates into more than one phase, this method may be advantageous in some cases. Initially each phase may be tested in the magnetic balance to determine which phase contains the highest concentration of free electrons.

According to another technique, the gravitation approach is combined with precipitation to create sedimentation. Precipitation is the process of separating the conductive structures by creating an environment where they agglomerate with each other or with other substances in the medium, to create larger particles. When these particles have a different density, they may be separated by gravity (sedimentation) or by a centrifuge. However, the larger particles created by precipitation may also make it easier to separate the conductive threads by filtration.

Precipitation may be induced using macromolecular material with more than 50% solvent in it, by changing temperature, pH, adding another solvent or by changing the concentration of solvent. For example, a second solvent may be added to a solution to create a poorer solvent and to separate out the structures that will not dissolve in the admixture of the poorer solvent. These methods are familiar to colloidal chemists. In this case the conductive thread is being considered a “particle” and is being precipitated in order to further process the medium and to produce an enriched medium or enriched material. Since toluene is often used to dissolve the polymer, the addition of alcohol may cause precipitation, e.g., by adding 5% per day until precipitation occurs. Precipitation will be seen as a cloudiness in the medium, and may concentrate at one level. Similarly, by lowering the temperature 5K per day the effect of temperature on precipitation may be observed.

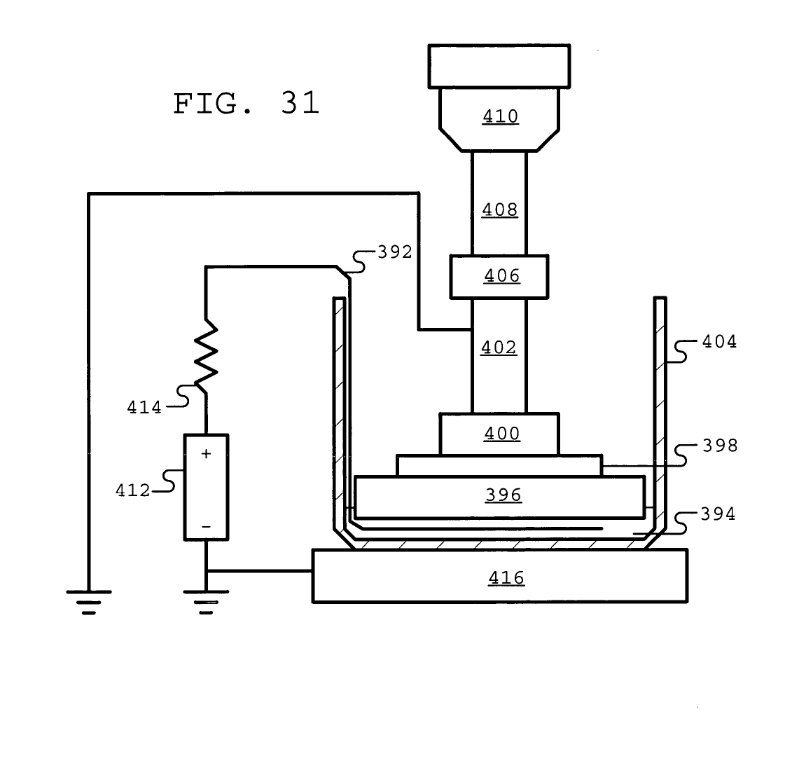

FIGS. 30A-D illustrate an enrichment technique based on diffusion of the macromolecular matrix. As shown in FIG. 30A, a container 376 has a bottom opening controlled by a valve 384. A quantity of macromolecular material 380 is placed in the container 376, possibly together with an optional substrate 378. An optional magnet 382 is positioned near the material 380. The container 376 is then filled with a solvent 386, as shown in FIG. 30B. The solvent 386 dissolves the macromolecular matrix to form a solution 388, leaving the enriched medium 390 on the substrate, as shown in FIG. 30C. The valve 384 is then opened, allowing most or all of the solution 388 to drain out of the container 376, leaving the enriched material 390 in the container, as shown in FIG. 30D.

Step 4: Forming a Conductor from the Compound

Once the macromolecular medium has been enriched, the material can then be used to form several types of conductors. For example, thin conductive films can be formed with the direction of conductivity perpendicular to the plane of the surface. In the case of films that are thinner than the average length of the fibrils, the enrichment process is not necessary for conduction through the film because the fibrils are already long enough to conduct through the film. The enrichment can, however, help produce a larger density of conductive channels through the film. For films much thicker than the average fibril length and for the creation of long wires, however, techniques are typically used to form longer threads, channels, and wires. Enrichment tends to produce longer conductive threads in the medium. Having created a sufficiently large density of threads by enrichment, the threads can then be joined by various techniques to form longer conductive structures. In principle, there is no theoretical limit to the length of an electronic thread that may be formed.

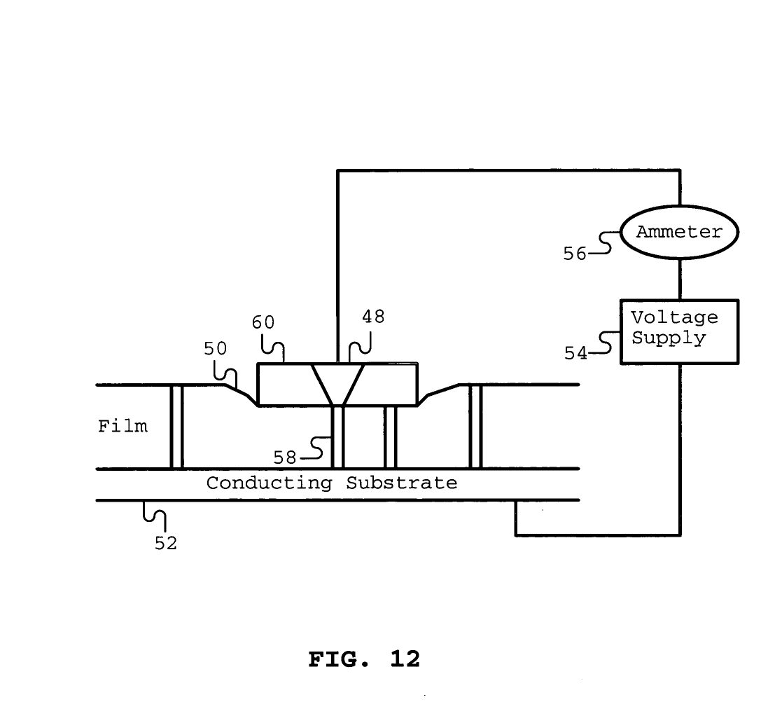

One approach to forming a conductor is to expose the medium to a strong homogeneous electric field, for example, by placing the medium between two metal plates and applying a high voltage across the plates. Due to the induced electric dipole moment of the threads, they will tend to rotate so they are aligned parallel to the field lines. In addition, the threads will tend to link up end-to-end, as is shown in FIG. 9, to form longer conductive threads. Note that some of the threads may join together in this manner during the enrichment process as well.

The same dipole attraction illustrated in FIG. 9 is also created when an alternating magnetic field is applied to the material. The flux change induces an alternating electric dipole moment in the threads that results in their mutual attraction. This mutual attraction can be enhanced by doping the medium with small conductive microscopic particles. Note that, although these particles are conductive, they do not participate substantially in the high conductivity through the material that is provided by threads.

Another method for creating longer threads is to place a thin film of the substance on a conductive substrate and place an electrode on the surface of the film. The electrode is initially used to apply an electric field that induces the creation of threads. When conduction through the medium is initiated, however, current pulses are sent through the conductive channel. When the channel can carry a significant current, say 1 Amp, then the electrode is raised slightly. The film should be kept in contact with the raised electrode by the application of pressure on the sides or by other techniques.

It is desirable in some devices to have thicker film (i.e., with a thickness of 80 microns or more), for example in order to reduce the flow of heat in thermal blockers and thermoelectric devices, while still conducting current. Another use for thick film is to cut it into sections where each section retained comprises at least one channel. These sections may then function as short lengths of wire, suitable for many purposes, such as microelectronic connections, and short antennas. Accordingly, the inventors have developed various techniques for producing thicker films comprising longer conductive threads and channels.

Layering Technique

Thin-layer techniques are limited in some cases to producing films that are less than 80 microns. Accordingly, one aspect of the invention provides techniques for producing films with a much greater thickness. One such technique is a layering approach that builds up a thick film from successive thin layers. An apparatus used to implement this technique is shown in FIG. 31. It includes an electrode 392 that extends into a glass container 404. The electrode 392 electrically contacts the bottom surface of a layer 394 of an enriched macromolecular medium. Covering layer 394 is an amount of enriched macromolecular solution 396. A steel electrode 398 is attached to magnet 400 which is attached to a grounded steel spacer 402 connected to another magnet 406. A micrometer 408 having a heated support is controlled by a fixed micrometer body 410. Magnet 406 is attached to micrometer 408, providing precise control over the vertical position of steel electrode 398. A 60 V DC power supply 412 is connected to the electrode 392 via a 100 kOhm current limiting resistor 414. Container 404 rests on a heated aluminum support 416. The principle of operation is to add solution 396 on top of the existing layer to create a new layer. The process can then be repeated to create a thick layer made up of many sub-layers. For example, the following technique was used to produce a conductive film 1 mm thick. First, an enriched medium is produced by first depositing a film. The film was made from polyoctylmethacrylate (POMA) with N,N,N′,N′-tetramethyl-1,4-phenylenediamine (Wurster's reagent) used as the dopant, in a toluene solution with the dopant about 4% wt. of the POMA. This solution was used to make a thin film layer, in the vicinity of 10 microns thickness, by dropping small amounts on a glass substrate and evaporating the solvent at about 60C and exposing it to UV radiation for 1 hour. About 7 days later, having given the film time for free electrons to self assemble, this film was dissolved in toluene to form about a 10% solution, and filtered through a 0.2 micron Teflon syringe filter, which was then back-flushed with toluene to create an enriched solution. Then, using the apparatus of FIG. 31, a tin electrode was attached to the bottom of a glass beaker, which was heated to about 40C, and the enriched solution poured into the beaker to cover the electrode with about 1-2 mm of solution. When the solvent had evaporated, a second electrode, which included a permanent magnet, was lowered on the film, using a micrometer so that the film thickness could be measured at this stage. A voltage of 10 volts was applied through a 100 kOhm resistor, and within a few minutes conduction occurred. The top electrode was then withdrawn by about 5 mm, detaching it from the film, and creating space for the solvent to evaporate. More enriched solution was then added to the beaker. The process was then repeated, until the conducting film was 1 mm thick.

The layering method described above includes the use of enrichment and achieves a film thickness much greater than any process without enrichment. This film of 1 millimeter, or 1000 microns, contained conductors of at least that length. This is the first time a “long” conductor of this type has been made, i.e., a conductor which exceeds 500 microns in length. Long conductors are commercially useful. For example, a 1 cm copper conductor today has a market as an antenna. Since superconductor antennas act as if they were many times their physical length, the 1 mm conductor created by the above method may be useful as a high frequency antenna.

Wire

The above layering method is not limited to films, but can be used to make conductors of an indefinite length, e.g., wires. Following the layering method, a technique for making wire involves the removal (disconnection) of an electrode from the formed conductor, and the addition of material containing threads at the end of the conductor. The electrode then contacts the new material and creates a channel between the previously formed conductor and the electrode, extending the length of the conductor. Wire typically consists of a core of conductive threads, preferably solidified by cross-liking, in a casing of a stronger material such as Kevlar. The core may be fabricated by the above method, or other methods such as those described below. In some cases the highly conductive core may be used as wire without additional strengthening materials, and several such cores, preferably twisted, may constitute strands in a thicker wire, which may carry higher currents.

Forming a Conductor from a High Viscosity Medium

The above technique of adding layers, and intermittently making contact to create conductivity, has the advantage of being used on a large area of film, e.g., about 2 cm diameter, which increases the probability of finding a conducting path, and creates a film which may contain a multitude of conductors. An alternative technique makes contact and establishes a conducting path, and then maintains the conductivity while the electrodes are separated. This technique has the advantage of not losing the conducting path, and may be extended indefinitely to create long wire as long as the supply of medium with free electrons is replenished.

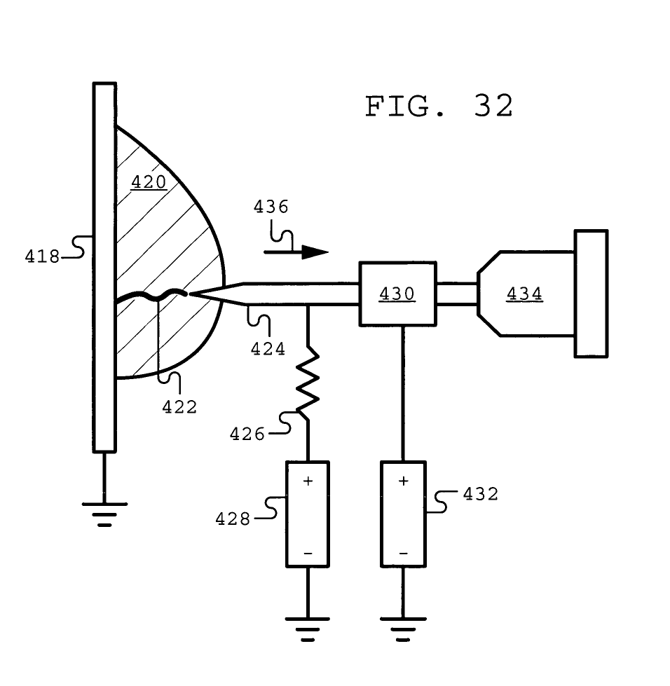

For example, FIG. 32 is an illustration of an apparatus used to implement such technique. A macromolecular material 420 (e.g., atactic polypropylene) was not enriched or doped but contained conductive threads composed of free electrons. A drop of the material 420 was placed on a flat heated electrode 418, and a small pointed electrode 424 was introduced to the medium 420. This electrode was positioned by a combination of a micrometer 434 and a piezoelectric device 430 to enable very smooth and precise motion. A variable voltage supply 432 controls piezoelectric device 430. With a small gap, less than about 10 microns, between the electrodes 418 and 424, a voltage was applied to electrode 424 using a voltage source 428 and a current limiting resistor 426. As a result, a conducting current was established through a conducting thread 422 formed in the medium 420. The small electrode 424 was then slowly withdrawn from the flat electrode 418 in a direction 436, increasing the gap, while maintaining the current. The drop of polymer 420 covered surfaces of both electrodes and the conductor 422 was contained within the drop. If in the process the circuit became open or the conductivity significantly decreased, the small electrode was temporary stopped or moved back slightly to decrease the gap until electric current was reestablished. Using this technique a conductive thread of length 130 microns was formed.

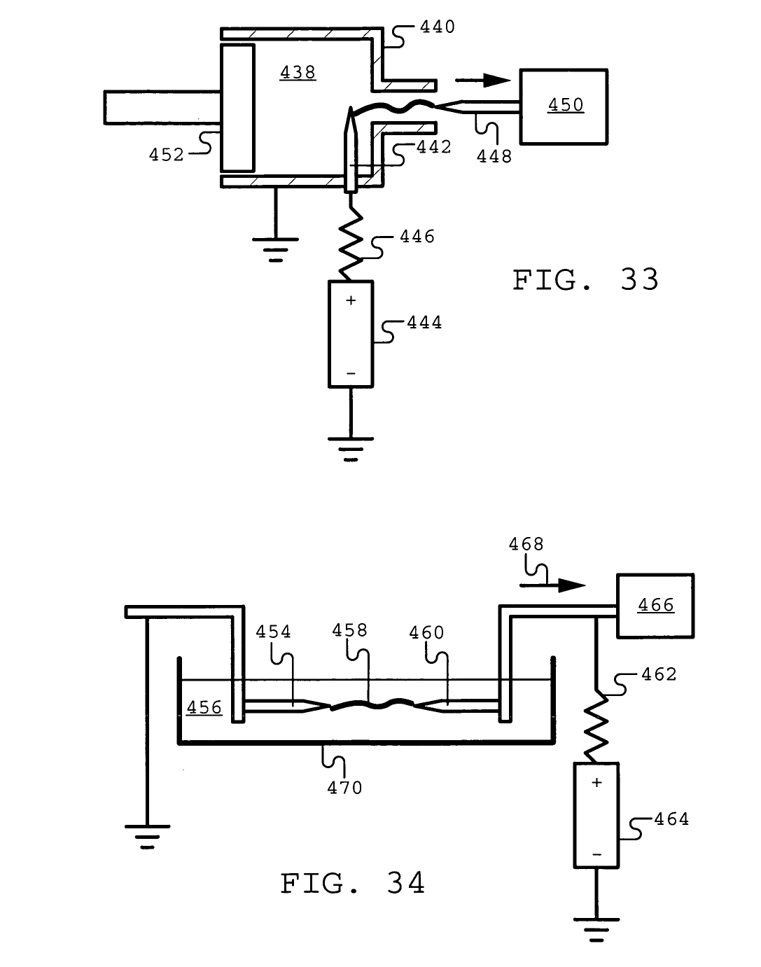

The above technique may be enhanced by using a doped and/or enriched conductive medium. The method may be used for longer wires or a continuous process by feeding the medium to the first electrode, which could be in the form of a feed tube. FIG. 33 illustrates a device used to implement this technique, according to one embodiment of the invention. A syringe-like container 440 having a piston 452 is filled with a macromolecular medium 438. A voltage source 444 is connected to a first electrode 442 via a current limiting resistor 446. The tip of first electrode 442 is positioned inside the container 440 near its exit channel. A second electrode 448 has its tip positioned just outside the exit channel of container 440 and its position is precisely controlled by a positioning device 450, such as a micrometer. The apparatus operates in a similar manner to that of FIG. 32, except that in this apparatus, as the thread is drawn out, additional medium can be provided by the movement of piston 452, forcing additional medium out of the container and into the gap between the electrodes. Another enhancement is to support and strengthen the resulting conductor, preferably by crosslinking the material.

Forming a Conductor from a Reduced Viscosity Medium

The discovery that conductive threads can survive in reduced viscosity liquids and gels under certain conditions enables new techniques for forming longer conductors using low viscosity material. There are many advantages to producing conductors in a reduced viscosity medium. First, the conductive threads are free to flow with the electric field forces, and can move quickly with little stress compared to flowing in a more viscous medium. Secondly, the solution may be at a similar density to the conductive threads and hence support them to reduce gravitational stress while the conductor is forming. Third, the field around the end of a conductor decreases rapidly with distance from the end, and hence the force attracting a conductive thread to the end of the conductor decreases with distance. In a low viscosity medium, the conductive thread will achieve a certain velocity with a smaller force, and hence threads will be drawn from a greater distance, giving access to a larger volume.

To provide an illustrative example, a conductor can be formed by the following technique, which will be described in relation to FIG. 34. A solvent is added to an enriched material, forming a solution or medium 456 preferably having the viscosity of a gel. Alternatively or in addition, the temperature of the material may be increased to form the medium 456. The viscosity may be reduced to a viscous gel, with viscosity about 100 N.s/m² or less, or for more rapid production down to about 0.1 N.s/m² or less. Since the viscosity is low, the medium is typically in a container or tube 470, but is not limited to such containment. Two electrodes 454 and 460, preferably pointed, are then introduced into this medium 456, with a small gap, in the vicinity of 1 micron, between their ends. A potential difference of about 10 volts to 100 volts is then applied across the electrodes using a voltage supply 464 connected to electrode 460 via a current limiting resistor 462. Preferably one or both electrodes have sharp points to create higher non-uniform electric fields, which will both attract and align conductive threads in the medium to form one or more conductive threads 458 connecting the two electrodes. Using a micrometer 466, the electrodes are slowly separated in a direction 468 at about 0.01 microns per second to 10 microns per second. Additional conductive threads join the conductor which is forming, induced by the electric field in the medium. Should the conductor break, the broken ends would be at the voltages of the electrodes, creating a strong electric field between the ends, drawing them together and pulling in more conductive threads. Once formed, the conductors may be solidified by evaporating the solution and/or by cooling, and preferably strengthened by crosslinking or other means.

A variant on the above technique may include application of an electromagnetic field, for example a magnetic field alternating at about 60 Hz to 6000 Hz with an amplitude up to about 500 oersted. The field may induce closed loops of conductive threads, which would be advantageous for creating highly conductive materials that have diamagnetic properties.

Continuous Process

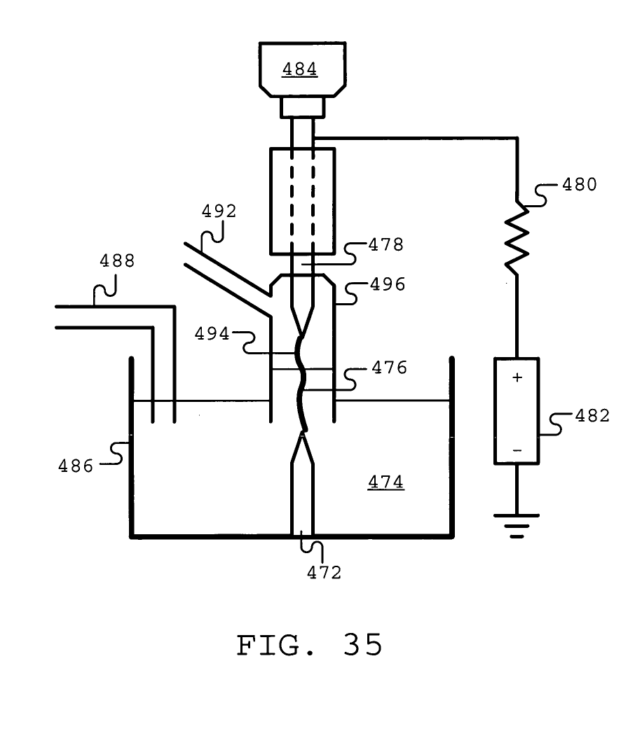

Another variant of the above method is for one or both electrodes to be moved out of the medium, drawing a conductor with it. The conductor may be drawn vertically because of the force of gravity on the flexible conductor, and it may then be solidified and preferably crosslinked or otherwise strengthened. One significant advantage of this technique is that the solution forms a large pool of conductive threads to draw on and can be replenished easily without disturbing the process, hence providing a continuous process. FIG. 35 shows an apparatus used to implement this technique. A fixed electrode 472 is fixed on the bottom of a copper container 486 filled with enriched macromolecular medium 474. Another electrode 478 has its vertical position precisely controlled by a micrometer 484. Electrode 478 is placed at a voltage by a power supply 482 connected to the electrode via a current limiting resistor 480. As in previously described techniques, the electrodes both begin within the medium and are separated slowly while maintaining conduction through forming threads 476 in the medium. In this technique, however, as electrode 478 is drawn slowly up above the surface of the medium 474, drawing a portion 494 of conductive thread 476 with it, a partial vacuum drawn through hose 492 draws the medium up into tube 496. To help prevent the exposed portion 494 from breaking, a technique is used to decrease its viscosity, for example, by cooling. The exposed portion 494 of the formed threads are preferably cooled below their glass transition temperature, thereby strengthening the threads and allowing a longer thread to be made. A hose 488 allows enriched macromolecular medium to be added so the supply 474 is replenished.

Powder Process

The powder process used for enrichment may be extended to making wire. As an example, the enriched fraction of the powder may be placed between two pointed electrodes, causing the more conductive particles to line up between the electrodes and electrically join together in some cases. The joining may be enhanced by raising the temperature if the powder is below its glass transition temperature or by using one of various techniques described below for electrically joining conductors.

The conductive particles may be quite mobile depending on their size and tendency to aggregate. If it is beneficial to increase the mobility, one approach is to suspend the particles in a fluid, preferably a fluid that results in a colloidal suspension. A second approach for particles that are lying on a surface, is to vibrate the surface to overcome the static friction with the surface.

According to another technique, the powder is packed into a tube and a voltage applied along the length of the tube to induce the joining of the conducting particles. A poor conductor may be used for the tube so that a large current is not required to establish the field. The powder in the tube may be heated to lower its viscosity, enabling the particles to move and rotate, until conduction through the tube is established. A similar technique is used for high temperature superconductor ceramics, but that technique is not the same, since the ceramic particles conduct in more than one direction.

Joining Conductors

The above methods may be adapted to provide methods for electrically joining existing conductors and wires by threads of highly conductive material. For example, existing macromolecular wires, crosslinked for strength, can serve as the electrodes in the above techniques, and will not dissolve in the solution since they are crosslinked. After the wires are electrically joined by the conductor formed in the liquid, the conductor may be solidified and cross-linked, forming a longer conductor. This technique can also be used to join or connect other types of conductors. Such conductors include and are not limited to: semiconductors, liquid conductors, ionic conductors, inherently conducting polymers, plasma conductors, superconductors, and carbon nanotubes.

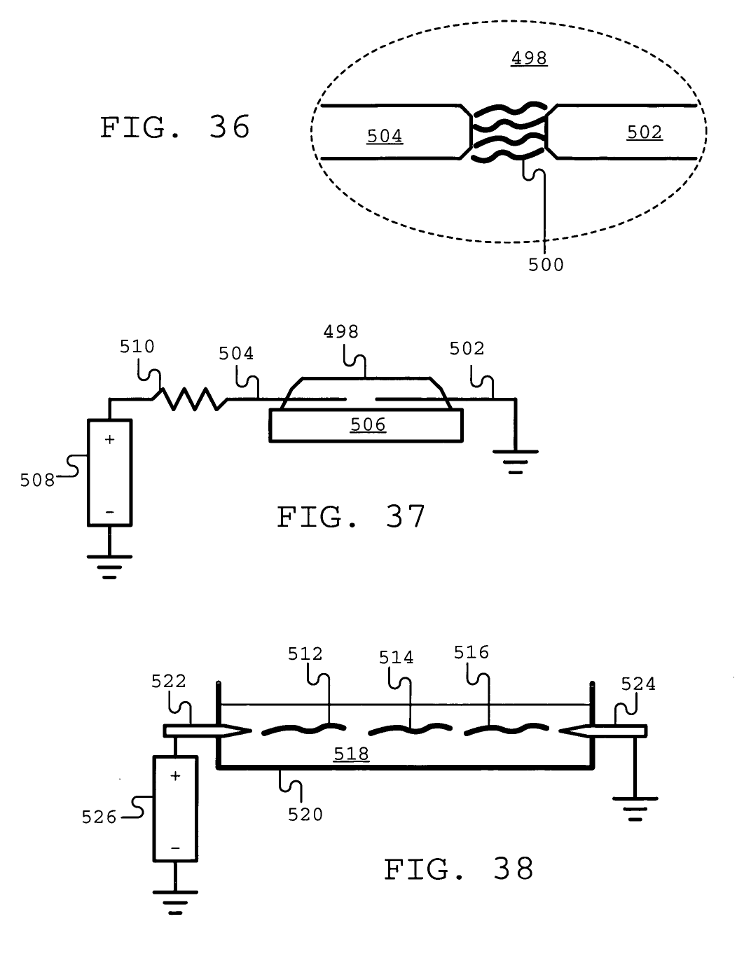

FIG. 36, for example, illustrates a close-up view of two conductors 502 and 504 whose tips are immersed in a macromolecular medium 498. A voltage applied between the conductors helps form the highly conductive threads 500 between their tips. As shown in FIG. 37, the two conductors 502 and 504 may be placed on a substrate 506 which supports them together with an amount of macromolecular medium 498. Conductor 502 is grounded while conductor 504 is attached to a +10 V potential 508 via a current limiting resistor 510. A technique for simultaneously joining several conductors 512, 514, 516 is shown in FIG. 38. As mentioned previously, these conductors could be any type of conductor. The technique involves placing the conductors in a container 520 filled with macromolecular material 518. Electrodes 522 and 524 positioned at opposite ends of the container are designed to create an intense electric field. Voltage source 526 supplies a potential to electrode 522, while electrode 524 is grounded. The conductors 512, 514, 516 are preferably positioned end-to-end with very small gaps between their ends. The electric field then induces threads to form between the conductor ends, electrically joining them together.

Stabilizing the Compound

Once the conductive threads or wires have been formed, they are generally stable structures. Brownian motion of the polymer segments, however, may cause the threads to be displaced within the medium. In particular, the ends of the threads will not necessarily remain at the surface of the medium or at the same place on the surface. Consequently, for some applications it is preferable to stabilize the macromolecular medium so that reliable electrical contact with the threads can be established at fixed points on the surface of the film. Stabilization also serves to strengthen the material and increase the lifetime of the conductive structures. The stabilization of the medium can be accomplished in several ways.

A first way to stabilize the medium is through cross-linking. As discussed in the above description of the initial macromolecular compounds, if specific chemical groups are included in the initial compound, then cross-linking may be produced between the macromolecules, thereby causing the medium to transform from a viscous liquid to an elastic solid state at room temperature. The cross-linking results in the appearance of a nonzero Young's modulus, which is a quantifiable measure that the medium has transformed into a substantially solid phase. In the case of the silicon-oxygen polymers, cross-linking may be produced by heating the substance at 150 C for 1.0-1.5 hours.

Another way to stabilize the medium is to increase the viscosity of the matrix so much that the Brownian motion becomes negligibly small. For example, the amorphous polymer matrix may be cooled below its glass transition temperature. Although such a cooled matrix is still a liquid in principle, its viscosity is so high that it has the properties of a solid. For compounds with a glass transition temperature below room temperature, the stable operation of the conductor takes place at a temperature below room temperature. Some compounds, however, have a glass transition point above room temperature. For these compounds, the steps of preparing the conductor take place while the medium is heated above room temperature, or while dissolved in a solvent. When the medium is then cooled to room temperature or the solvent evaporated, the conductor naturally stabilizes. In the case of polyurethane, cooling below 62 C is connected with the formation of microcrystals in the macromolecular medium. It should be noted that if the content of microcrystal exceeds approximately 50% by volume, then the conductivity may disappear.

Yet another way to increase the viscosity of the macromolecular matrix is to introduce small amounts of hard microscopic particles into the matrix. Preferably, these particles are small non-conductive balls having a diameter of 0.01 μm and up to 10% concentration by volume. This technique is especially effective in the case of the polyurethanes because microscopic crystals are produced in the amorphous phase of the matrix, causing it to become more viscous. Note that these particles may also be used to enhance the ionization and creation of free electrons. In this case, only 1 vol % concentration is needed.

The essential result of the various techniques for stabilization is to give the medium the properties of a solid. In particular, the inventors have found that sufficient stabilization is produced when the Young's modulus of the medium is at least 0.1 MPa. In accordance with this teaching, it will be appreciated by those skilled in the art that other techniques may be used for producing a Young's modulus of at least 0.1 MPa, thereby causing the required stabilization. Preferably, the Young's modulus is at least 0.1 MPa. More preferably, it is at least 0.2 MPa, and most preferably, the Young's modulus is at least 1.0 MPa.

Conductors produced by the above methods typically have the characteristic properties shown in column 7 of Table 1. The other columns list the corresponding properties of other known types of conductors.

TABLE 1

| | Metals and | | | | Compound | published | |
|---|---|---|---|---|---|---|---|
| | metal | | Superconducting | Conjugated | of | polymer | |
| | alloys | Ceramics | Salts | polymers | Bourgoin | films | Invention |
| Molecular | inorganic | inorganic | low | high | high plus | high | high |
| Weight | | | | | metal | 70K-300K | >1,000 |
| Room Temp. | <10\hat{ } 6 S/cm | <10\hat{ } 4 S/cm | low, SC at | <10\hat{ } 5 S/cm | >10\hat{ } 6 S/cm | >10\hat{ } 11 S/cm | >10\hat{ } 11 S/cm |
| Conductivity | | | T < 12K | | | | |
| Crystal-linity | Poly- | Poly- | Crystal | Poly- | ? | ˜0 vol % | <50 vol % |
| | crystal | crystal | | crystal | | | |
| Single Bonds | N/A | Many | Few, many | Few, many | Many | Many | Many |
| | | | double | double | | ˜100% | >76.8% |
| Young's | >10\hat{ } 4 MPa | >10\hat{ } 4 MPa | >10\hat{ } 4 MPa | >10\hat{ } 3 MPa | ? | 0 (liquid) | >0.1 MPa |
| Modulus | | | | | | | |
| Oxygen Content | <0.1% | >30% | may be | 0 | some | 3-5% | 0.1-13% |
| | | | present | | | | |
| Static Dielec. C | ∞ | ? | ? | ∞ | ? | >4.0 | >2.4 |
| Low MW doping | no | no | yes | yes | no | no | no |
| | | | sometimes | | | | |
| Conduct. | no | no | no | no | yes | no | no |
| Particles | | | | | | | |
| Conduct. | very high | high | very high | moderate | ? | low | very high |
| Stability | | | | | | | |

It should be emphasized that physical models have been employed in the above description in order to motivate the procedure and provide a deeper understanding of the essential properties of the conductors and methods for producing them. The presentation of this model, therefore, provides teaching that enables those skilled in the art to perform many variations and alterations of the details without undue experimentation. Nevertheless, it should also be emphasized that the particular disclosed steps for preparing electrical conductors enable anyone skilled in the art to practice the invention independent of the specific models. For example, the following procedure describes the steps performed to produce a particular conductor without making any reference to the model.

Detailed Example: Producing a Highly Conductive Film

In one embodiment of the invention, a highly conductive material is prepared in the form of a thin film 30 positioned on a conductive substrate 32, as shown in FIG. 10. The material that is produced will have a number of small conductive channels 34 through the film separated by dielectric regions 36. The film will have anisotropic electric conductivity corresponding to the orientations of the channels, typically in a direction predominantly normal to the surface of the film.

Step 1

Form a mixture of PDMS having vinyl end groups (at 60 vol. % with molecular weight about 100,000) and the copolymer differing from this in that it has hydrogen side substitutes (at 40 vol. % with molecular weight 5,000). This mixture will initially be a viscous liquid at room temperature.

Step 2

Dissolve the polymer medium in an appropriate solvent such as toluene such that the concentration of the polymer substance in the solution does not exceed 1%. A conductive substrate is cleaned with the solvent and the solution is sprayed onto the surface of the substrate using a gas flow of dry nitrogen. The temperature of the substrate during spraying should be maintained between 40 C and 70 C. The exact temperature and the rate of spraying are controlled such that the drops of solution falling on the surface dry before the next drop falls on the same point. The duration of the spraying depends on the thickness of the film desired. Spraying is performed for about an hour to obtain a film 15 μm thick.

Although free electrons are spontaneously formed during and after spraying, this process is preferably quickened by UV treatment of the film. In the preferred embodiment, a 120 Watt mercury lamp having a 5 cm tube at a working pressure of 0.2-0.3 MPa is positioned about 5 cm from the film for 4-6 hours at room temperature. The UV exposure should be continued until the ferromagnetic susceptibility indicates that the mean concentration of the free electrons in the film exceeds at least 3×10¹⁷ electrons/cm³. The ferromagnetic susceptibility can be measured by the well known Faraday method.

Steps 3 and 4

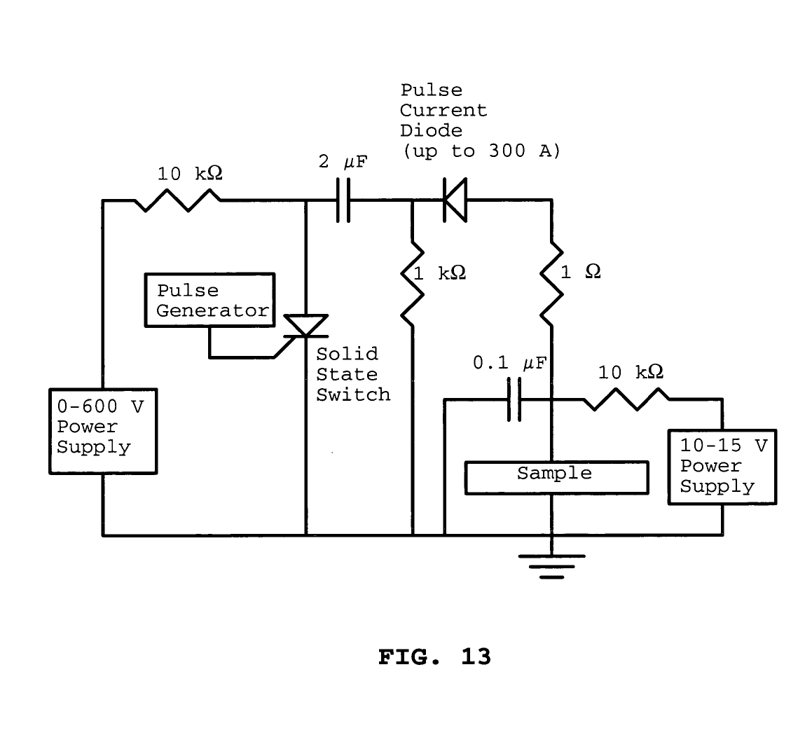

In the case of a thin film conductor steps 3 and 4 may be combined as follows. As shown in FIG. 11, a conductive plate 38 with a layer of insulating material 40 is positioned close to the film 42 which is positioned on a conductive substrate 44. AC voltage is applied by a high voltage power supply 46 to create a mean electric field intensity of 20-25 kV/cm between the conductive substrate and the conductive plate. The alternating voltage should be applied for approximately ten days.

In the final stage of conductor preparation, the polymer medium is heated to 150 C for 1.5 hours. Preferably, the high voltage applied during the previous step is maintained during this heating period. As a result of heating, the macromolecular medium will transform into an elastic solid and the Young's modulus should exceed the minimum value of 0.1 MPa. After the completion of this step the film is ready to be used.

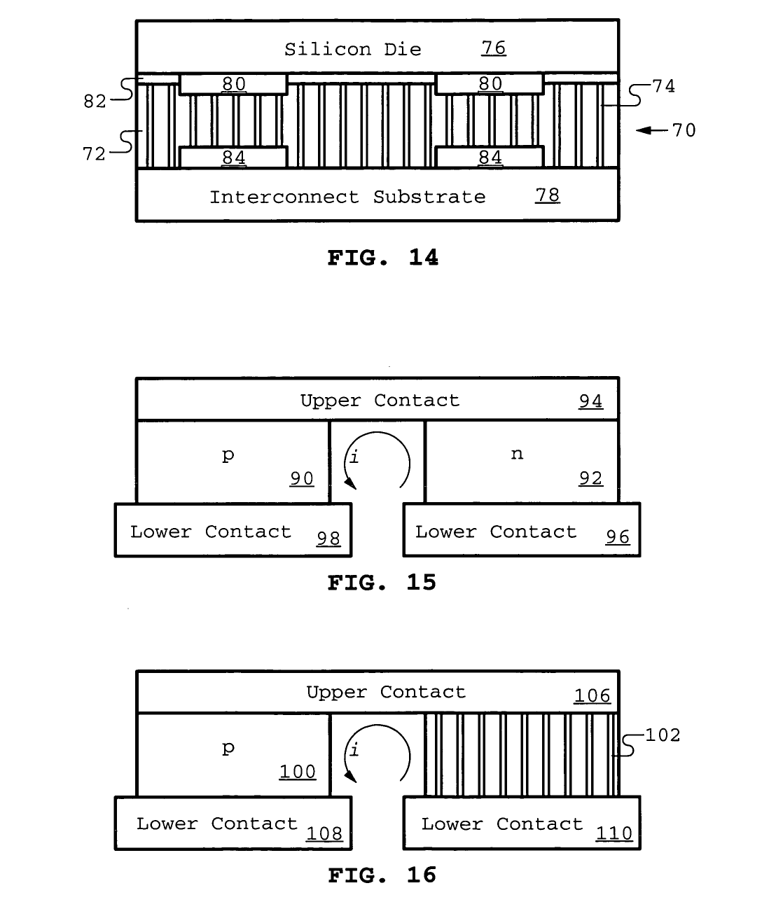

If all the steps of the preparation have been completed with care, the density of g conductive channels through the film may be as large as 10,000 channels/cm², having an average spacing of about 0.1 mm. The typical mean diameter of each conductive point on the surface is 2 μm to 4 μm. The conductivity through the film may be tested as shown in FIG. 12 by placing a flat conductive electrode 48 firmly on the upper surface of the film 50 and applying a voltage between the electrode 48 and a conductive substrate 52 upon which the film 50 rests. A voltage supply 54 is used to apply the voltage and an ammeter 56 measures the resulting current. To measure the properties of individual conductive channels 58 in the film, the flat electrode 48 should firmly contact only a small area of the film surface. In order to prevent damage to the film due to the application of force to such a small area, the electrode is preferably provided with a protective insulating ring 60 as shown.

Preferably, the electrode 48 is made of copper or gold and the insulating ring 60 is made of glass or hard plastic. The surface diameter of the electrode can be easily made as small as 10 μm to 50 μm using this technique. Care should be taken that the electrode is polished and coplanar with the ring so that it properly contacts the film.

The total resistance of the substrate-channel-electrode system can be measured and used to calculate an upper limit on the resistance of the channel by subtracting the resistances of the substrate, the electrode, and the tunnel resistances at the contact points. Using a current not exceeding 50 mA the resistance of the channel can at times be measured to be less than 0.001 Ω. Based on a channel diameter of 2 μm to 4 μm and a length of 15 μm, it follows that the conductivity of the channel is significantly more than 10⁶ S/cm.

The conductivity of the channels can be measured more precisely using a current of 200 mA or more. This corresponds to a current density of over 10⁶ A/cm², so it is applied in short pulses to avoid local damage to the electrodes. Current pulses as large as 10-20 A can be used if their half-width is a microsecond or less. Simple calculations based on measurements of the heat generated in the film as a result of these pulses place an upper limit of 10⁻⁵ Ω on the resistance of a channel. It follows that the conductivity of the channel exceeds 10⁸ S/cm.

Alternate Embodiments

Table 2 shows the various preparation parameters used for various alternate embodiments of the invention.

TABLE 2

| | | | Silicon-Oxygen based polymer | | | | |
|---|---|---|---|---|---|---|---|
| | | | | | vinyl end | vinyl end | |
| | | | | grps, some | grps, | | |
| | Hydrocarbons | | | vinyl end | with H side | diphenyl | |
| | APP | IPH | PDMS | groups | grps | side grps | Polyurethane |
| Mol. Weight in | 4-100 | 300-1000 | 300-1000 | 15-100 | 75-100, | 2-10 | 4.5-10 |
| kDa | | | | | 2-10 | | |
| Single Bond | 100% | 100% | 100% | >99% | >97.5% | >76.8% | >97% |
| Content | | | | | | | |
| Polymer Solvent | heptane | heptane | toluene | toluene | toluene | toluene | dimethyl- |
| | | | | | | | formamide |
| Film Prep. | 40-70 C. | 40-70 C. | 40-70 C. | 40-70 C. | 40-70 C. | 40-70 C. | 80 C 24 hr |
| Conditions | 0.5-4 hr | 0.5-1 hr | 0.25-1 hr | 0.25-1 hr | 0.25-1 hr | 0.25-1 hr | |
| Initial Dielectric C. | 1.9-2.0 | 1.9-2.0 | 2.7 | 2.7 | 2.7 | 2.7 | 4.0 |
| Thermo- | 1-2 hr | 1-2 hr | None | None | None | None | None |
| oxidation | 100-110 C. | 100-110 C. | | | | | |
| Final content of | 0.1-5 | 0.1-5 | 10 | 10 | 14 | 2.8-3.1 | 6.6-15.7 |
| oxygen | atomic % | atomic % | atomic % | atomic % | atomic % | atomic % | atomic % |
| UV exposure time | 1-1.5 hr | 1-1.5 hr | 4-6 hr | 4-6 hr | 4-6 hr | 4-6 hr | 1-1.5 hr |
| Final Dielectric C. | >2.4 | >2.4 | 2.7 | 2.7 | 2.7 | 2.7 | 4.0 |
| Production | 18-20 C. | 18-20 C. | 18-20 C. | 18-20 C. | 18-20 C. | 18-20 C. | 80 C. |
| Temperature | | | | | | | |
| Time for Cond | 2-14 days | 1-7 days | 3-10 days | 3-10 days | 3-10 days | 3-10 days | 10-30 min |
| creation | | | | | | | |
| Stabilization | cool to −20 C. | cool to −55 C. | cool to | 150 C for | 150 C for | 150 C for | cool to 62 C. |
| Process | | | −130 C. | 1.5 hr | 1.5 hr | 1.5 hr | |
| Final Crystal | 0% | 0% | 0% | 0% | 0% | 0% | <50% |
| Phase Content | | | | | | | |
| Max. Film | 50-80 μm | 20-25 μm | 15-18 μm | 15-18 μm | 15-18 μm | 12-15 μm | 20 μm |
| Thickness | | | | | | | |

Note that the fifth column in the table corresponds to the 60%-40% mixture of two compounds used for producing the film of the preferred embodiment.

It should be noted that it is possible to enhance conductivity by carefully “training” the samples with a long set of current pulses of gradually increasing amplitude. Smooth bell-shaped pulses with 1-10 μs half-width repeated at 1-10 Hz are used. The initial pulse amplitude is 1 mA or less per channel and the final pulse amplitude is 10 Amps per channel. The amplitude is increased linearly with time for 30-60 min. Well-trained “young” samples of silicon based polymer have maximal current amplitude of about 10 Amps/channel. On the other hand, “old” samples can have a maximal (critical) current of over 200 Amps/channel. Well-trained samples can keep low resistivity for several hours in some cases while carrying little or no current. The circuit used to train the samples is shown in FIG. 13. This training technique can enhance the conductivity by raising the allowed current densities and by lowering the resistivity.

Devices Comprising Highly Conductive Materials

The inventors have discovered that the above methods may be used to produce new and useful devices of various types, which will now be described.

Interposer

One type of device made using a highly conductive material is an interposer device, i.e., a thin or thick film electrical connector, normally with a plurality of parallel channels which are electrically isolated from one another. In addition to exploiting the highly conductive properties of the films, these interposer devices also exploit the unique property of anisotropic conduction enjoyed by these films. The film shown in FIG. 10, for example, has no conduction between distinct channels, and has all the channels oriented roughly normal to the surface of the film. Consequently, the film conducts electricity only in the direction normal to the surface of the film, and does not permit the flow of electricity in any direction parallel to the film surface. Thus, the film is a particular type of anisotropic conductor. Because the films of the present invention are naturally anisotropic conductors, they can be used as interposers in various devices, as will be described now in more detail.

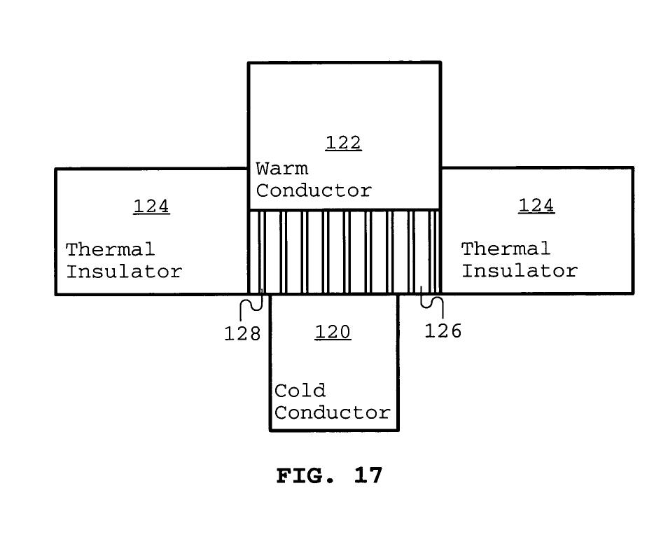

One embodiment of an electrical interposer according to the present invention is illustrated in FIG. 14. The interposer 70 is a layer of highly conductive film comprising a dielectric medium 72 and conductive channels 74 oriented normal to the surface of the film. The film 70 is positioned between a silicon die 76 and interconnect substrate 78. The die 76 has conductive pads 80 and insulating regions 82. Similarly, the substrate 78 also has conductive pads 84. The conductive pads on both the silicon die and the substrate are in direct contact with the interposer film. The conductive channels 74 in the film provide electrical conduction through the film between pads 80 of the die and pads 84 of the substrate. Only pads which are opposed to each other on the two sides of the film are electrically connected by the channels in the film. The interposer, therefore, is useful as an electrical “flip-chip” connector used, for example, in chip scale packaging. The interposer may also be used in a similar way between two interconnect substrates. Because the interposer has anisotropic conductivity, it does not need to be patterned as some other interposers known in the art. The interposer of the present invention also enjoys the advantage that the channels are typically separated by 10 microns or less, allowing a much higher density of distinct interconnections through the film than is provided by other known techniques, such as conductive fillers in epoxy. Yet another advantage of the interposer of the present invention is that it is capable of carrying much more current and has lower resistivity than any other interposers known in the art.

Protective Layer With Conductive Properties

Another application of the conductively anisotropic film is to provide a protective layer on the surface of a conductor. For example, the film illustrated in FIG. 10 may be a polypropylene film on a copper substrate. The film will protect the copper against chemical corrosion and oxidation. In contrast with other protective films, however, the present film does not electrically insulate the substrate, but provides excellent conduction through the film via the conductive channels. As a result, the protected substrate can still be used as an electrical connector or electrode. The film thus acts as an electrical interposer between the conductive substrate and other conductive elements which may be used to conductively contact the substrate through the film.

Free-standing Films

A freestanding film or membrane can also be used in a variety of ways, as an intermediate production step for a device, or as a device such as a magnetic shield. According to one embodiment, a freestanding film is produced by peeling the film off the substrate, for example with a blast of air. In order to maintain the integrity of the film in isolation from the substrate, it may be necessary to strengthen the film, preferably by cross linking, or by reducing the temperature below the glass transition temperature. Another technique for producing a freestanding film is to make the film on a substrate that can be dissolved, etched, or otherwise removed from the film without damaging the film itself. For example, the film can be made on a sodium chloride substrate that is then dissolved with water, leaving just the film.

Thermoelectric Devices

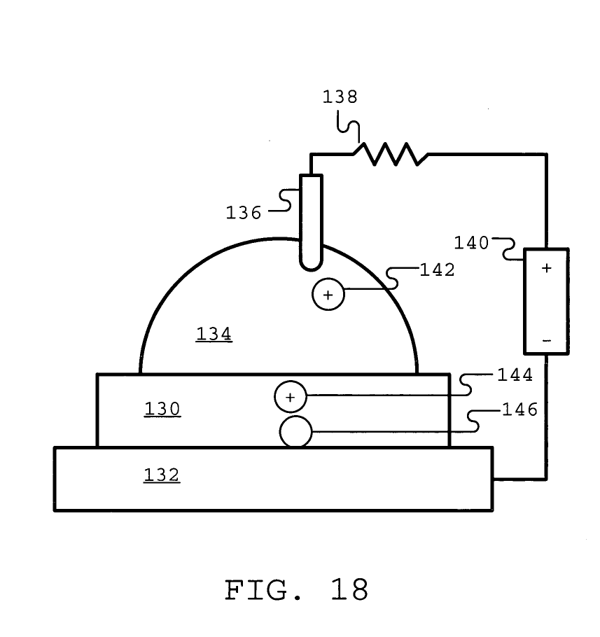

It has been reported in the art that the Z factor of a thermoelectric device can be increased by using a conventional superconductor as the passive leg of the device. Although the material of the present invention is distinct in certain respects from conventional superconductors, it shares with superconductors the property of violating the Wiedemann-Franz law. Thus, the inventors have recognized that a film of the present invention can be used to provide an improved thermoelectric device that does not suffer from the disadvantage that it requires cooling to liquid Nitrogen temperatures. FIG. 15 is a cross-sectional diagram illustrating a conventional thermoelectric device having two active legs, a p-type leg 90 and an n-type leg 92. The legs are both connected to an upper contact 94, and to separate lower contacts 96 and 98. By passing an electrical current i from lower contact 96 to lower contact 98 via the upper contact 94, heat is pumped from the upper contact 94 to the lower contacts 96 and 98, causing the upper contact to be cold and the lower contact to be hot. Conversely, the device can also be used to generate current from a thermal differential between the upper and lower contacts.

The figure of merit, Z, for the conventional device is approximately the average of the figures of merit, Zₙ and zₚ, of the two materials used for the legs. The value of z for a leg is given by z=α²σ/λ, where α is the Seebeck coefficient, λ is the thermal conductivity and σ is the electrical conductivity. The value of Z for the device may be increased from 95% to 99% by constructing the device with a film of the present invention, as shown in FIG. 16. The device in this case has a p-type leg 100 as in the conventional device. Instead of the n-type leg, however, the device of the invention is composed of a film interposer 102 of the present invention. As in the conventional device, the legs are both connected to an upper contact 106, and to separate lower contacts 108 and 110. The increase in Z for this device is due to the fact that, with the highly conductive leg substituted, the Z of the device is no longer the average of the z values for the two legs, but is approximately equal to the z value of the active leg. Thus, to optimize the Z for the device requires only the optimization of z for the active leg.

Thermal Insulator with Conductive Properties

Highly conductive films according to the invention are also useful for conductive electrical power or signals while blocking the flow of heat. This unique combination of properties is desirable, for example, when a circuit is refrigerated and needs to be thermally isolated from heat flow from other circuits with which it is in electrical contact. FIG. 17 is a cross-sectional diagram illustrating a thermal barrier employing a conductive material of the present invention. A conductor 120 in a low temperature region is thermally insulated from a conductor 122 in a high temperature region by conventional thermal insulation 124 and a film interposer 126 comprising conductive channels 128. The film provides thermal insulation between the two conductors while conductive channels in the film provide electrical contact between the conductors. This arrangement might be used, for example, in an infrared detector, or to thermally insulate a cooled superconductor from ambient temperature electrical circuits.

Fault Current Limiters

The films of the present invention can also be used as a fault current limiter, i.e., to limit the current when there is a fault or short circuit that needs to be isolated from other circuits. The two circuits in this case are connected by a film of the present invention. If a current larger than a maximum critical current is passed through the film, the resistance of the film becomes very large, thereby limiting the flow of current and electrically isolating one circuit from the other. This is not the same as a fuse, since the increase in resistance is not due to a heating effect.

Electromagnetic Shielding

Highly conductive films of the present invention can also be used as electromagnetic shielding. In this particular application, it should be noted that the threads need not form channels connecting one surface to the other, and need not be commonly oriented. An anisotropy of the threads, however, can be used to provide the film with certain unique properties. For example, with the conductive threads all oriented in one direction, the interaction of the film with incident electromagnetic waves will depend on the relative orientation between the waves and the thread orientation. The film can thus be used for reflecting and polarizing electromagnetic waves, or for modulating signals.

Field Emitter Devices

Field emitter devices (FEDs) are used in many applications such as flat screen displays. The FED is based on the emission of electrons at the microscopic tip of a conductor, where the electric field is inversely proportional to the radius and is consequently very high. The films as shown in FIG. 10 will emit from the ends of the channels, and may be used as FEDs, typically with individual control of the voltage on each channel. Channels for an FED would be typically less than 1 micron diameter, and preferably less than 0.1 micron diameter.

Pressure Switches

The highly conductive film may also be used as a pressure switch, by being made an interposer between two conductors. In a preferred embodiment the film in this case is produced with threads near the surface, but no channels at zero pressure. When pressure is applied through the conductor, the film is deformed and some threads become channels, connecting the previously isolated conductors.

Diamagnetic Materials

According to another aspect of the invention, new diamagnetic materials are provided, as well as novel methods for making diamagnetic materials. Two of the present inventors reported on diamagnetic properties of macromolecular materials in “Observation of Extremely Large, Field-Dependent Diamagnetism at 300K in Certain Disordered Organic Materials,” by D. N. Rogachev and L. N. Grigorov, Journal of Superconductivity: Incorporating Novel Magnetism, Vol. 13, No. 6, 2000. One aspect of the present invention provides methods for reliably and efficiently producing diamagnetic materials with superior properties. The large diamagnetism observed in such macromolecular materials is associated with the conductive threads, especially when there is a high density of free electrons—that is, in an enriched material. The diamagnetic materials preferably have a concentration of free electrons that exceeds 2×10¹⁸ cm⁻³. Producing such materials is facilitated by techniques to create such high concentrations by doping and/or enriching the material.

Diamagnetism may be described as the capacity of a material to produce a magnetic field in opposition to an applied field. Diamagnetism is seen in superconductors, which are highly diamagnetic, and in materials such as bismuth, which is weakly diamagnetic. There are natural diamagnetic materials, such as bismuth which has magnetic susceptibility kappa=−1.3*10⁻⁵ CGS units. For the strongest natural diamagnetic material at room temperature, graphite, (parallel to the axis) kappa=−5*10⁻⁵ CGS units. Roughly, this corresponds to 6*10⁻²% of the “super conducting phase” in the material (comparing it to a superconductor). Samples of macromolecular diamagnetism have been measured up to about −250*10⁻⁵ CGS units, which is about 50 times the susceptibility of the strongest element. There are no materials known to the inventors that exceed graphite unless they are superconductors or diamagnetic macromolecular materials. The range of susceptibility demonstrated by macromolecular materials is currently in the range of about −1.0*10⁻⁵ CGS units to −250*10⁻⁵ CGS units. More typical diamagnetic macromolecular materials have a susceptibility about −10.0*10⁻⁵ CGS units.

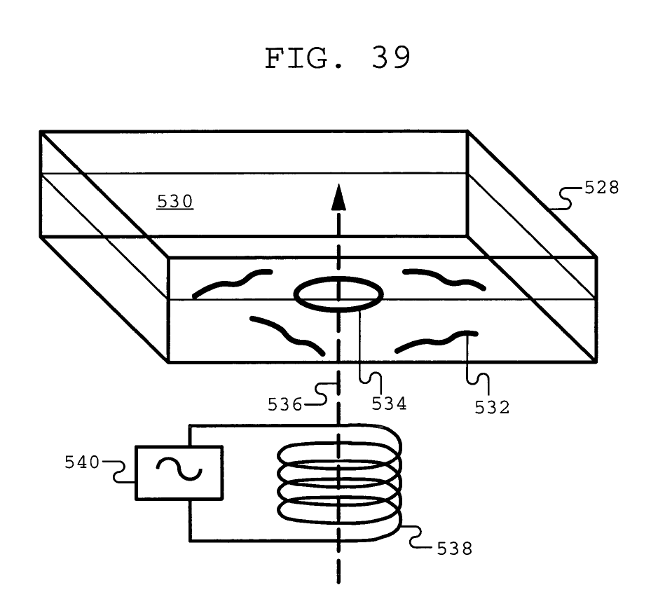

In typical production, a fraction of enriched material is naturally diamagnetic. Samples exhibiting this phenomenon may be identified by the strong diamagnetic reaction in a magnetic balance; that is, a force in the opposite direction to the more common ferromagnetic response. A model which explains the diamagnetism is that the conductive structures form continuous loops, and the persistent currents induced in those loops create a field which opposes any external magnetic field according to the Lenz induction law. A sample of material containing conductive structures may have some natural structures forming loops, giving a diamagnetic response, and other structures not in loops which contribute to the ferromagnetic response. Hence the presence of diamagnetic material may be partially or completely masked by the ferromagnetic material. For clarity a diamagnetic macromolecular material is one with a diamagnetic response exceeding about (for example −2.0*10⁻⁵ CGS units). An aspect of the present invention provides a method for producing a diamagnetic material which includes application of an electromagnetic field to a highly conducting medium. For example, FIG. 39 illustrates an apparatus that may be used to implement such a method. A container 528 holds a quantity of enriched macromolecular medium 530 containing highly conductive threads 532. An alternating voltage source 540 connected to a coil 538 creates a magnetic field 536 in close proximity to the medium 530. For example a magnetic field alternating at about 60 Hz to 6000 Hz with an amplitude up to about 500 oersted may be used. This field 536 facilitates the formation of closed loops of conductive threads 534 within the medium. This technique can be used in conjunction with the earlier described patterned activation that creates closed loops.

High magnetic fields, typically greater than about 1000 oersteds (0.1 tesla), may destroy the diamagnetism in an enriched material if the sample has not been protected. The word “protect” will be used in this context for the methods which serve to preserve the diamagnetism in the macromolecular material. Some methods of protection may preserve it in higher fields than others. While the material sample is unprotected it is easy to change its character from diamagnetic to ferromagnetic by exposing the material to a high magnetic field, typically greater than about 0.1 tesla. The high magnetic field induces a current J, which in turn creates a “hoop stress” on the loop proportional the the applied induction B, namely B×J. That hoop stress causes stretching of the loop, and at a given point, the loop is broken. The magnetic field strength at which such loop rupture occurs depends on the mechanical properties (e.g., young modulus, creep and yield strength) of the embedding medium. Thus improving such properties increase the field strength that can be applied without loop rupture.

Hence one method of creating diamagnetic material is to first create an enriched material, with a free electron density more than about 10¹⁸ per cc, preferably more than about 10¹⁹ per cc. Samples of such material may be tested in a magnetic balance or an apparatus to screen diamagnetic from ferromagnetic material, exposing the samples only to low magnetic fields, e.g., less than about 500 oersteds (0.05 tesla), until the samples are protected. The maximum safe field will typically depend on the material and its temperature. The numbers here are typical for atactic polypropylene at about room temperature. The next step is to protect the diamagnetic samples.

A second method of creating diamagnetic material is to first create an enriched material, with a free electron density more than about 10¹⁸ per cc, preferably more than about 10¹⁹ per cc. The second step is to protect the samples, in which case the screening may be done in a higher magnetic field. The benefit of a higher field is that the screening for diamagnetism could be done in a simpler, less sensitive device. The diamagnetic samples are then selected.

In the second method, the protection method could be lowering the temperature of the samples below their glass transition temperature, and this could be done just for the duration of the screening cycle, without causing a permanent change in the samples. The diamagnetic samples may then be protected in a more permanent way, and the ferromagnetic samples are available for further processing.

There are many ways to protect the diamagnetism in the sample. One technique is solidification, which can be accomplished by cross-linking the material, or by reducing and keeping the temperature of the sample below its glass transition temperature. The cross linking for certain materials such as silicon based polymers may be accomplished by heating. Other polymers may be cross-linked by UV light or X-rays. A magnetic field of about 500 oersteds may aid in the cross-linking or solidification, orienting the diamagnetic response in a specific direction.

Another approach to solidification is by adding to the material some type of microscopic particles such as glass beads of about 4-10 micron diameter. These may be added, for example, by gently mixing, possibly in a solvent, in about a 1% to 10% ratio to the material. Another approach is attaching the material by adhesion to a solid surface, such as glass or a strong polymer such as Kevlar. Since the magnetic field tends to generate an outward pressure the solid surface may surround the volume of macromolecular material to constrain the material.

Diamagnetic Devices

There are many useful devices that are enabled by the availability of diamagnetic macromolecular material. The known materials, such as bismuth, may be too weak to be effective, or too expensive, or too heavy, and the other alternative, superconductors, either ceramic or metal, need cryogenic temperatures to function.

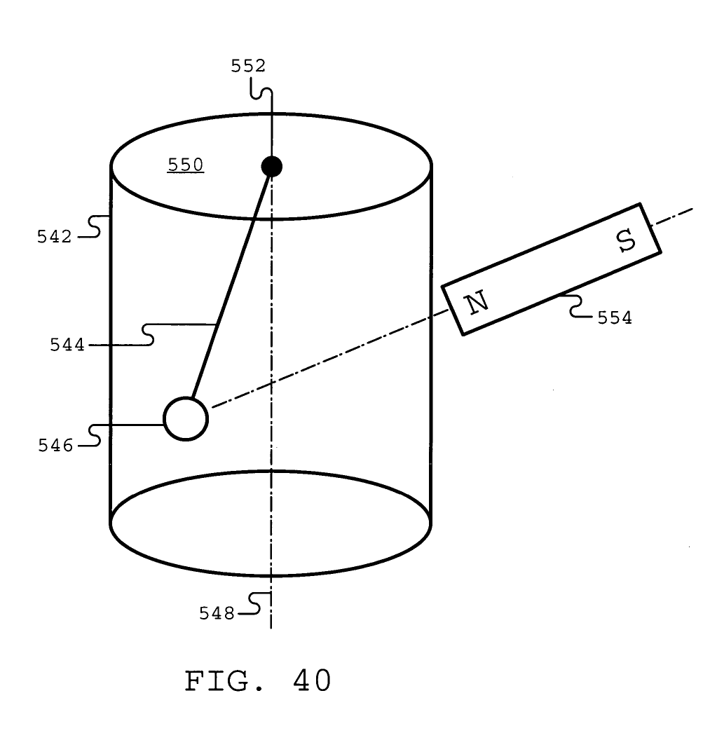

There can be many devices comprising macromolecular material with diamagnetism exceeding −1.0*10⁻⁵ CGS units interacting with a magnetic field. The magnetic field could be produced by a permanent magnet, by the earth, by an electric coil or other means. If the force between the material and the field is measured, this can lead to a number of instruments. For example measuring the magnetic field, or sensing when a field is present. FIG. 40 illustrates one such device. A glass container 542 has a top 550 with a suspension point 6 at its center. A highly diamagnetic material 546 is suspended by a filament 544 from suspension point 6. In the absence of a magnetic field, the material 546 will align with a vertical axis 548. When a magnetic field is present, such as from a magnet 554, material 546 will be displaced from the vertical axis 548. By measuring the displacement, the magnetic field can be measured.

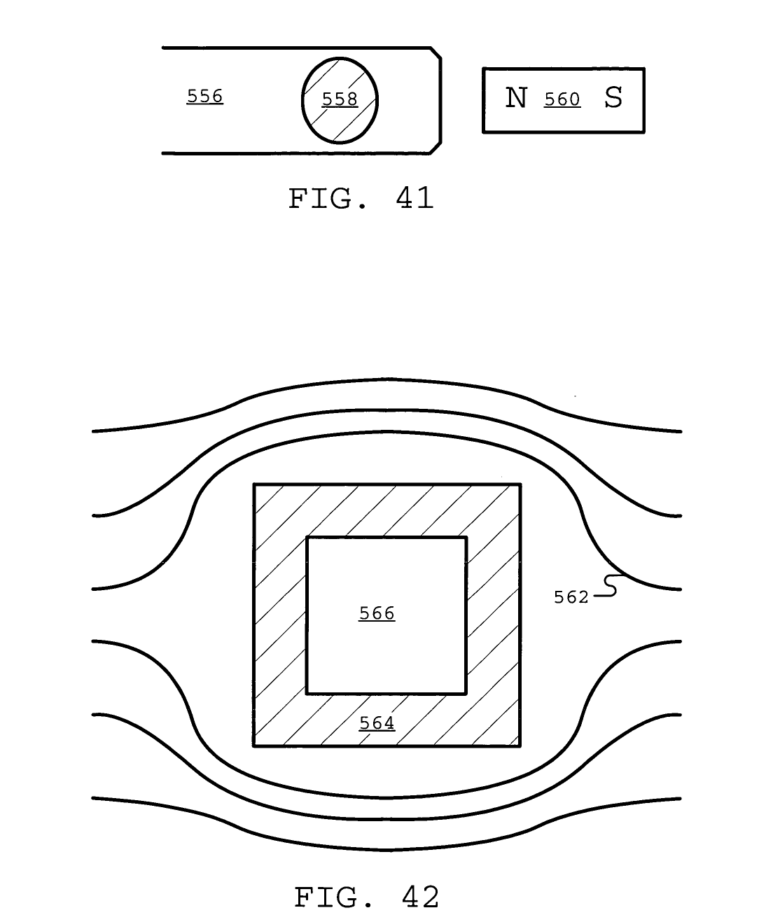

The force may also be used to move or position the material (or conversely the field source) such as levitating the diamagnetic material, or levitating a permanent magnet. FIG. 41 illustrates the basic principle of such a device. A container 556 has within it a piece of highly diamagnetic material 558. In the presence of a magnetic field, such as from magnet 560, material 558 will experience a force upward. If the force is stronger than the weight of the material, it will levitate. Concrete applications are for minimizing friction as in bearings and sliding surfaces. This could be of value for the heads in magnetic disc files.

The diamagnetic material develops a field which counteracts and negates, or at least locally attenuates, any field applied. Hence it is an excellent way of shielding an area from magnetic fields, both steady fields and alternating fields. Since some electronic equipment is sensitive to magnetic fields, shielding is a valuable property. The diamagnetic material may replace such materials as mumetal for shielding. For example, FIG. 42 illustrates a region 566 (e.g., containing an integrated circuit) that is shielded from a magnetic field 562 by a highly diamagnetic material 564.

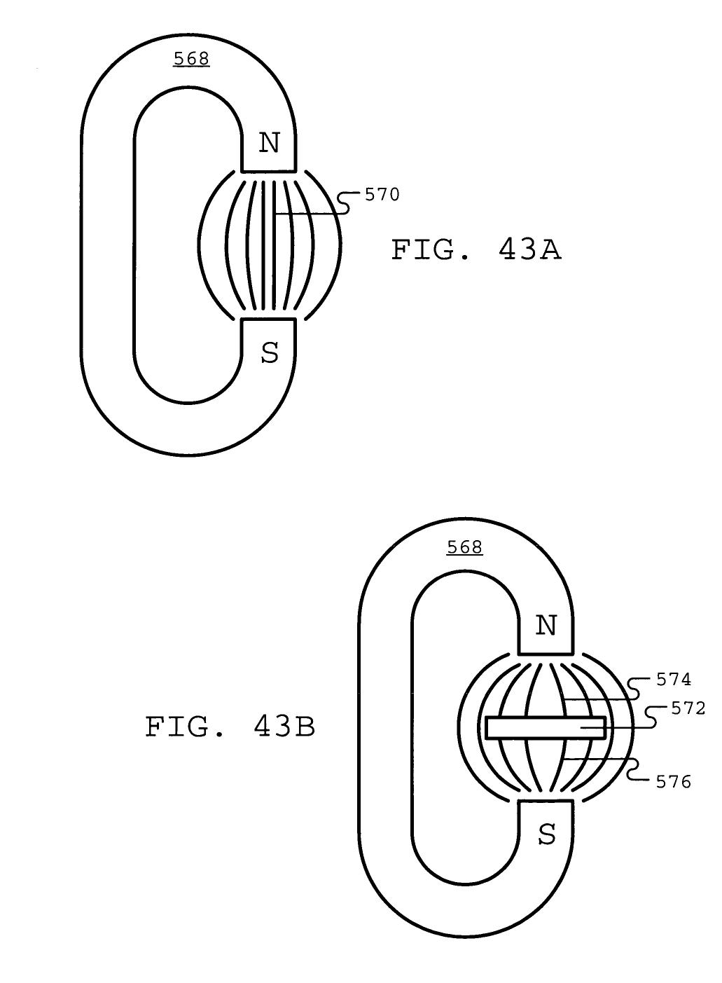

Shielding is just one example of modifying a magnetic field. For example if an area on the axis of a disc of diamagnetic material is shielded, the magnetic field at the edge of the disc will generally be stronger than the field in that location if the disc were not present. Hence the disc can enhance the field, and can change the field dynamically if the disc is moving. This is a simple example that illustrates the principle which can be used in an application. An application could be that an instrument needs a certain magnetic field configuration to bend electron beams. The diamagnetic material would then be used with specially configured magnets to shape the field. For example, FIGS. 43A-B illustrate how a diamagnetic material can be used to shape or alter a field. In FIG. 43A is shown a magnet 568 that has an associated magnetic field 570. Note that the field is especially intense in the central line between the north and south poles of the magnet. Now, if a highly diamagnetic material 572 is placed along this central line, as shown in FIG. 43B, then the field lines are altered. In particular the field is now weak in regions 574 and 576 that had high intensity before the material 572 was introduced.

The above are all examples of useful devices that may use diamagnetic macromolecular material, and are meant to be representative, not exhaustive.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

1. A method comprising:
providing a macromolecular medium comprising highly conductive threads;
decreasing the viscosity of the macromolecular medium;
processing the macromolecular medium; and
increasing the viscosity of the macromolecular medium;
wherein the viscosity of the macromolecular material is decreased to 100 N.s/m² or less;
wherein no more than 50% of the highly conductive threads disintegrate during the duration of time between the decreasing and the increasing.

2. The method of claim 1 wherein the duration is 4 hours or less.

3. The method of claim 1 wherein the decreasing reduces the viscosity of the macromolecular material to 0.1 N.s/m² or less.

4. The method of claim 1 wherein no more than 10% of the highly conductive threads disintegrate during the duration of time.

5. A method comprising:
providing a macromolecular medium comprising highly conductive threads;
adding a solvent to the macromolecular medium to form a solution;
processing the macromolecular solution; and
evaporating the solvent from the macromolecular solution;
wherein the macromolecular solution has a viscosity of 100 N.s/m² or less;
wherein no more than 50% of the highly conductive threads disintegrate during the dissolving.

6. The method of claim 5 wherein the dissolving comprises mixing the macromolecular medium in the solvent for 15-30 minutes.

7. The method of claim 5 wherein a duration of time between the dissolving and evaporating is 3 hours or less.

8. The method of claim 5 wherein the macromolecular solution has a viscosity of 0.1 N.s/m² or less.

9. A method comprising:
providing a macromolecular medium comprising highly conductive threads;
depositing a layer of solvent upon a layer of the macromolecular medium;
allowing a portion of the macromolecular material to diffuse into the solvent;
removing the solvent comprising the diffused portion to obtain a retentate of enriched macromolecular material.

10. The method of claim 9 further comprising applying a magnetic field to the layer of the macromolecular medium.

11. A method comprising:
providing a macromolecular medium comprising highly conductive threads;
pulverizing the macromolecular medium to produce a powder comprising particles;
separating the particles using an electromagnetic field into particles containing highly conductive threads and particles containing substantially no highly conductive threads; and
collecting the particles containing highly conductive threads to obtain an enriched conductive powder.

12. The method of claim 11 wherein no more than 50% of the highly conductive threads disintegrate during the pulverizing.

13. The method of claim 11 wherein the electromagnetic field is a static electric field.

14. The method of claim 11 wherein the electromagnetic field is a static magnetic field.

15. The method of claim 11 wherein the pulverizing is performed at a temperature below a glass transition temperature of the macromolecular medium.

16. The method of claim 11 wherein no more than 10% of the highly conductive threads disintegrate during the pulverizing.

17. The method of claim 11 further comprising subjecting the collected particles to an electric field such that the collected particles electrically join to form a highly conductive material.

18. The method of claim 17 wherein the electric field is created using two pointed electrodes.

19. The method of claim 17 wherein the collected particles are heated above a glass transition temperature of the collected particles.

20. The method of claim 11 wherein the macromolecular medium is an enriched medium.

21. The method of claim 11 further comprising heating the collected particles above a glass transition temperature of the macromolecular medium.

22. The method of claim 11 further comprising packing the collected particles into a tube and applying a voltage between ends of the tube.

23. The method of claim 22 wherein the packed particles are heated above a glass transition temperature of the packed particles during the application of the voltage.

24. The method of claim 22 wherein the packed particles are heated during the application of voltage such that the viscosity of the packed particles is 100 N.s/m² or less.

25. A method comprising:
providing a macromolecular material comprising free electrons;
dissolving the macromolecular material in a solvent to form a lower viscosity medium;
subjecting a portion of the lower viscosity medium to an electromagnetic field so that a concentration of free electrons in the portion of the lower viscosity medium is increased;
collecting the portion of the lower viscosity medium; and
evaporating the solvent from the portion of the lower viscosity medium to obtain an enriched macromolecular material.

26. A method comprising:
providing a macromolecular material comprising free electrons;
fractionating the macromolecular material to produce fractions having differing concentrations of free electrons; and
collecting a first fraction having a highest concentration of free electrons to obtain an enriched macromolecular material.

27. The method of claim 26 wherein the fractionation comprises multiple diffusion paths in a porous medium.

28. The method of claim 26 wherein the fractionating comprises adsorption.

29. The method of claim 26 wherein the fractionating comprises deabsorption.

30. The method of claim 26 further comprising collecting a second fraction having a second-highest concentration of free electrons and combining the first fraction with the second fraction to obtain the enriched macromolecular medium.

31. The method of claim 26 wherein the fractionating comprises subjecting the macromolecular medium to a force causing the medium to flow.

32. The method of claim 31 wherein the force is produced by an electromagnetic field.

33. The method of claim 31 wherein the force is produced by a pressure differential.

34. The method of claim 26 further comprising heating the macromolecular material to reduce its viscosity.

35. The method of claim 26 further comprising adding a solvent to the macromolecular material to reduce its viscosity.

36. The method of claim 26 wherein the fractionating comprises inducing differing flow rates between the fractions using an electromagnetic field.

37. The method of claim 26 further comprising heating the macromolecular material to reduce its viscosity.

38. The method of claim 26 further comprising adding a solvent to the macromolecular material to reduce its viscosity.

39. A method comprising:
providing a macromolecular material comprising free electrons;
dissolving the macromolecular material in a solvent to form a solution;
flowing the solution along a surface of an active solid, wherein an interaction between the active solid and the flowing solution separates the flowing solution into fractions having differing concentrations of free electrons;
collecting a separated fraction of the solution to obtain an enriched macromolecular material.

40. The method of claim 39 wherein the concentration versus time is calibrated, and collection is made at the time of highest concentration.

41. A method comprising:
providing a macromolecular medium comprising free electrons;
separating the macromolecular medium into fractions having differing concentrations of free electrons; and
collecting a first fraction having a highest concentration of free electrons to obtain an enriched macromolecular medium.

42. The method of claim 41 wherein the separating comprises precipitation and the first fraction comprises a precipitate.

43. The method of claim 41 wherein the macromolecular medium contains more than 50 weight % of a solvent.

44. The method of claim 41 wherein the separating comprises adding a second solvent to cause precipitation.

45. The method of claim 41 wherein the separating comprises changing a concentration of the solvent to cause precipitation.

46. The method of claim 41 wherein the separating comprises changing a temperature of the macromolecular medium to cause precipitation.

47. The method of claim 41 wherein the separating comprises changing a pH of the macromolecular medium to cause precipitation.

48. A method comprising:
providing a macromolecular medium comprising free electrons;
inducing the medium to form a precipitate having an increased concentration of free electrons;
subjecting the macromolecular medium to a gravitational force such that the precipitate is separated; and
extracting the precipitate to obtain an enriched macromolecular medium.

49. A method comprising:
providing a macromolecular medium comprising free electrons;
filtering the macromolecular medium to produce a retentate having an increased concentration of free electrons; and
collecting the retentate to obtain an enriched macromolecular medium.

50. The method of claim 49 further comprising lowering the viscosity of the macromolecular medium prior to filtering.

51. The method of claim 50 wherein lowering the viscosity comprises heating the macromolecular medium.

52. The method of claim 50 wherein lowering the viscosity comprises adding a solvent to the macromolecular medium.

53. The method of claim 49 wherein filtering comprises passing the macromolecular medium through a cross-flow filter.

54. The method of claim 49 wherein collecting the retentate comprises back flushing a filter.

55. The method of claim 49 wherein filtering comprises increasing a differential pressure across a filter.

56. The method of claim 55 wherein increasing the differential pressure comprises creating a vacuum.

57. The method of claim 55 wherein increasing the differential pressure comprises employing a centrifuge.

58. The method of claim 49 wherein collecting comprises extracting a filter material and dissolving the filter material using a solvent.

59. The method of claim 58 wherein the filter material is a salt.

60. The method of claim 58 wherein the salt is sodium chloride.

61. The method of claim 58 wherein the salt is compacted.

62. The method of claim 58 wherein the solvent is water.

63. A method comprising:
providing a macromolecular medium comprising highly conductive threads and a remaining macromolecular medium;
separating the highly conductive threads from the remaining medium using a technique based on a density difference between the highly conductive threads and the remaining medium;
forming an enriched macromolecular medium from the separated highly conductive threads.

64. The method of claim 63 wherein the technique comprises centrifuging the macromolecular medium.

65. The method of claim 63 further comprising reducing the viscosity of the macromolecular medium prior to separating.

66. The method of claim 65 wherein reducing the viscosity comprises heating the macromolecular medium.

67. The method of claim 65 wherein reducing the viscosity comprises adding a solvent to the macromolecular medium.

68. The method of claim 63 further comprising lowering the temperature to increase viscosity after the separating.

69. A method comprising:
providing on a conducting substrate a layer of film composed of a macromolecular material comprising at least one conductive channel;
depositing on an exposed surface of the layer of film a second layer of film composed of a macromolecular medium comprising highly conductive threads;
coupling an electrode to an exposed surface of the deposited second layer of film;
applying a voltage between the electrode and the conducting substrate until a predetermined level of current flows; and
decoupling the electrode from the exposed surface of the deposited second layer of film.

70. The method of claim 69 wherein the conducting substrate comprises a metal conductor.

71. The method of claim 69 further comprising evaporating a solvent from the deposited second layer of film.

72. The method of claim 69 further comprising evaporating a solvent from the deposited second layer of film.

73. The method of claim 69 wherein the predetermined level of current is greater than 1 mA.

74. The method of claim 69 wherein the macromolecular medium is an enriched macromolecular medium.

75. The method of claim 69 wherein the macromolecular medium has a viscosity of 100 N.s/m² or less.

76. The method of claim 69 wherein the macromolecular medium comprises a dopant.

77. The method of claim 69 further comprising exposing the second layer of film to a magnetic field for at least a part of the duration of the application of the voltage between the electrode and the conducting substrate.

78. A method comprising:
providing a macromolecular medium comprising free electrons;
providing a first highly conductive macromolecular material;
providing a second highly conductive macromolecular material;
placing a portion of the macromolecular medium between the first highly conductive material and the second highly conductive material; and
applying a voltage between the first highly conductive material and the second highly conductive material until a predetermined level of current flows to form a conjoined highly conductive macromolecular material.

79. The method of claim 78 further comprising evaporating a solvent from the portion of the macromolecular medium.

80. A method comprising:
providing a macromolecular medium comprising free electrons;
providing a first highly conductive material;
providing a second highly conductive material;
placing a portion of the macromolecular medium between the first highly conductive material and the second highly conductive material; and
applying a voltage between the first highly conductive material and the second highly conductive material until a predetermined level of current flows to form a conjoined highly conductive material.

81. The method of claim 80 further comprising evaporating a solvent from the portion of the macromolecular medium.

82. The method of claim 80 wherein the first or second highly conductive materials is a superconductor.

83. The method of claim 80 wherein the first or second highly conductive materials is a carbon nanotube.

84. The method of claim 80 wherein the first or second highly conductive materials is a one-dimensional conductor.

85. A method comprising:
providing a macromolecular medium comprising free electrons;
providing a first electrode and a second electrode such that the first electrode and second electrode are separated by a non-zero distance;
depositing a portion of macromolecular medium between the first electrode and the second electrode;
applying a voltage between the first and second electrodes until a current flows;
increasing the non-zero distance between the first electrode and the second electrode; and
applying a second voltage between the first and second electrodes until a current flows, thereby producing a highly conductive thread within the portion of macromolecular medium.

86. The method of claim 85 further comprising maintaining the first electrode and second electrode in physical contact with the deposited portion of macromolecular medium.

87. The method of claim 85 further comprising evaporating a solvent from the deposited portion of macromolecular medium.

88. The method of claim 85 wherein the current is at least 1 mA.

89. The method of claim 85 further comprising decreasing the non-zero distance between the first electrode and the second electrode if a current does not flow after a predetermined period of time.

90. The method of claim 85 wherein the first electrode has a pointed tip with a radius of curvature less than 1 micron.

91. The method of claim 85 wherein the second electrode has a pointed tip with a radius of curvature less than 1 micron.

92. The method of claim 85 wherein the macromolecular medium has a viscosity of 100 N.s/m² or less.

93. The method of claim 85 wherein the macromolecular medium comprises a dopant.

94. The method of claim 85 wherein the macromolecular medium is reduced in viscosity.

95. The method of claim 85 further comprising adding a second portion of macromolecular medium to the deposited portion, thereby allowing a length of the produced highly conductive thread to be increased.

96. The method of claim 85 wherein the first electrode and second electrode are highly conductive macromolecular materials.

97. The method of claim 85 further comprising enriching the macromolecular medium.

98. The method of claim 85 wherein the macromolecular medium has a viscosity of 100 N.s/m² or less.

99. The method of claim 85 wherein the non-zero distance is initially less than 100 microns.

100. The method of claim 85 wherein increasing the non-zero distance withdraws a portion of the produced highly conductive thread out of the deposited portion of macromolecular medium.

101. The method of claim 100 further comprising increasing the viscosity of the withdrawn portion of macromolecular medium.

102. The method of claim 101 wherein increasing the viscosity comprises evaporating a solvent.

103. The method of claim 101 wherein increasing the viscosity comprises cooling.

104. The method of claim 101 wherein increasing the viscosity comprises inducing crosslinking.

105. The method of claim 85 further comprising adding a portion of enriched macromolecular medium to the deposited portion.

106. The method of claim 85 wherein the first electrode and second electrode are resistant to decomposition by the deposited macromolecular medium.

107. The method of claim 85 wherein the first electrode and second electrode are cross-linked highly conductive macromolecular materials.

108. A macromolecular material comprising a conductive thread longer than 500 microns with conductivity greater than 10⁶ S/cm.

109. A method comprising:
providing an enriched macromolecular medium comprising free electrons;
producing a macromolecular material from the enriched macromolecular medium;
wherein the produced macromolecular material has a diamagnetism exceeding −1.0*10⁻⁵ CGS units;
wherein the yield of the produced macromolecular material is at least 10%

110. A method comprising:
providing an enriched macromolecular medium comprising free electrons;
producing a macromolecular material from the enriched macromolecular medium;
wherein the produced macromolecular material has a diamagnetism exceeding −10.0*10⁻⁵ CGS units;
wherein the yield of the produced macromolecular material is at least 1%.

111. A device comprising a macromolecular material with diamagnetism exceeding −1.0*10⁻⁵ CGS units.

112. A device comprising a macromolecular material with diamagnetism exceeding −10.0*10^{31 5} CGS units.

113. The device of claim 112 wherein the material is responsive to a magnetic field.

114. The device of claim 112 wherein the material alters a magnetic field.

115. The device of claim 112 wherein the material levitates in response to an external magnetic field.

116. The device of claim 112 wherein the material partially shields portions of the device from an external magnetic field.

117. The device of claim 112 wherein the device produces an output responsive to an external magnetic field.

118. A method comprising:
providing a macromolecular material with diamagnetism exceeding −1.0*10⁻⁵ CGS units;
solidifying the macromolecular material such that the diamagnetism of the material is preserved in the presence of magnetic fields up to at least 1000 oersted.

119. The method of claim 118 wherein the solidifying comprises cooling the macromolecular material below a glass transition temperature.

120. The method of claim 118 wherein the solidifying comprises cross-linking the macromolecular material.

121. The method of claim 120 wherein the cross-linking is performed in a magnetic field.

122. The method of claim 118 wherein the solidifying comprises adding microscopic particles to the macromolecular material.

123. The method of claim 118 wherein the solidifying comprises attaching the macromolecular material to a solid surface.

124. The method of claim 118 wherein the solidifying comprises encapsulating the macromolecular material in a solid substance.

125. A method comprising:
providing a doped macromolecular medium comprising free electrons;
producing a macromolecular material from the doped macromolecular medium;
wherein the produced macromolecular material has a diamagnetism exceeding −1.0*10⁻⁵ CGS units;
wherein the yield of the produced highly conductive macromolecular material is at least 1%

126. A method comprising:
providing a macromolecular medium;
ionizing portions of the macromolecular medium to facilitate the creation of free electrons in the macromolecular medium;
collecting the ionized portions to form a macromolecular material comprising free electrons.

127. The method of claim 126 wherein the ionizing comprises spraying drops of the macromolecular medium.

128. The method of claim 127 wherein the spraying comprises applying an electromagnetic field.

129. A method comprising:
providing a macromolecular medium;
providing an ionized gas; and
combining the ionized gas with the macromolecular medium to facilitate the creation of free electrons in the macromolecular medium, thereby producing a macromolecular material comprising an increased number of free electrons.

130. The method of claim 129 wherein providing the ionized gas comprises exposing a gas to a high intensity electric field, thereby ionizing the gas.

131. The method of claim 130 wherein the high intensity electric field is greater than 30 kilovolts/cm.

132. A method comprising:
providing a macromolecular medium;
providing ions; and
implanting the ions within the macromolecular medium to facilitate the creation of free electrons in the macromolecular medium, thereby producing a macromolecular material comprising an increased number of free electrons.

133. The method of claim 132 wherein providing the ions comprises forming the ions using electrolysis.

134. The method of claim 132 wherein providing the ions comprises ionizing a gas;

135. The method of claim 132 wherein implanting the ions comprises directing the ions into the macromolecular medium with an electric field.

136. The method of claim 132 wherein implanting the ions comprises:
lowering a viscosity of the macromolecular medium; and
passing the macromolecular medium through a gas of the ions.

137. The method of claim 136 wherein passing the macromolecular medium through a gas of the ions comprises forming drops of the macromolecular medium, and wherein implanting the ions further comprises collecting the drops.

138. The method of claim 132 wherein providing the ions comprises:
generating the ions through a triboelectric interaction between the macromolecular medium and a second material.

139. The method of claim 132 further comprising lowering the viscosity of the macromolecular medium.

140. A method comprising:
providing a macromolecular medium;
providing a source of electrons; and
implanting electrons from the source of electrons within the macromolecular medium to facilitate the creation of free electrons in the macromolecular medium.

141. The method of claim 140 wherein the implanting is facilitated by an electric field.

142. The method of claim 140 wherein the source comprises a scanning electron microscope.

143. The method of claim 140 wherein the source comprises a cathode.

144. The method of claim 140 wherein the source comprises a field emission device.

145. A method comprising:
providing a macromolecular material; and
implanting electrons in the macromolecular material in accordance with a predetermined pattern, thereby producing a patterned macromolecular material comprising a patterned distribution of free electrons.

146. The method of claim 145 wherein the implanting comprises directing an electron beam toward the macromolecular material.

147. A method comprising:
providing a macromolecular material; and
creating free electrons in the macromolecular material in accordance with a predetermined pattern, thereby producing a patterned macromolecular material comprising a patterned distribution of free electrons.

148. The method of claim 147 wherein the creating comprises directing a laser beam toward the macromolecular material.

149. A method comprising:
providing a macromolecular material;
depositing the macromolecular material on a substrate; and
electrically charging a portion of the substrate such that free electrons are generated in the deposited macromolecular material.

150. The method of claim 149 wherein the charging comprises imposing a voltage for at least 1 hour after the depositing.

151. The method of claim 150 wherein the voltage exceeds 5000 volts.

152. The method of claim 149 wherein the substrate is conductive, and wherein the charging comprises imposing a voltage from a voltage source.

153. The method of claim 149 wherein the charging comprises exposing the substrate to positive or negative ions.

154. The method of claim 149 wherein the charging comprises exposing the substrate to electrons.

155. The method of claim 149 wherein the charging comprises exposing the substrate to a charged material.

156. The method of claim 149 wherein the substrate is a dielectric, and wherein the charging comprises creating a large electrical potential in proximity to the substrate.

157. The method of claim 149 wherein the charging comprises temporarily contacting the substrate with a second material.

158. The method of claim 157 wherein the contacting comprises triboelectric interaction.

159. The method of claim 157 wherein the substrate is glass and the second material is paper.

160. The method of claim 157 wherein the substrate is glass and the second material is a fluorocarbon resin

161. The method of claim 149 further comprising exposing the macromolecular material to ultraviolet light.

162. The method of claim 149 further comprising exposing the macromolecular material to laser light.

163. The method of claim 162 wherein the laser light has a frequency at or above ultraviolet frequency.

164. The method of claim 162 wherein the laser light is tuned to produce a two-photon ionization in the macromolecular material.

165. A method comprising:
providing a macromolecular medium;
irradiating the macromolecular medium with laser light such that free electrons are formed in the macromolecular material, thereby producing a macromolecular material with increased concentration of free electrons.

166. The method of claim 165 wherein the laser light has a frequency at or above ultraviolet frequency.

167. The method of claim 165 wherein the laser light is tuned to produce a two-photon ionization in the macromolecular material.

168. A material composition comprising: a macromolecular material and a dopant, wherein the material has a conductivity of 10⁶ S/cm or greater.

169. A method comprising:
providing a macromolecular material;
adding a dopant to the macromolecular material to produce a doped macromolecular material;
generating ions in the doped macromolecular material, thereby producing free electrons in the doped macromolecular material.

170. The method of claim 169 wherein adding the dopant comprises electrolysis.

171. The method of claim 169 wherein the dopant is a material having an ionization potential below 6.95 eV.

172. The method of claim 169 wherein the dopant is a material having an ionization potential below 5.4 eV.

173. The method of claim 169 wherein the dopant is a material selected from the group consisting of elements, inorganic molecules and radicals, and organic and element-organic compounds.

174. The method of claim 169 wherein the dopant is material selected from the class of 3d and 4f transition metals.

175. The method of claim 169 wherein generating ions comprises exposing the macromolecular material to radiation.

176. The method of claim 169 wherein the dopant is an organic salt.

177. The method of claim 169 further comprising cross-linking the ionized, doped macromolecular material.

178. A method comprising:
providing a macromolecular material;
adding a first dopant to the macromolecular material to produce a doped macromolecular material;
adding a second dopant to the doped macromolecular material to produce a doubly-doped macromolecular material, wherein the second dopant reacts with the first dopant to create free radicals; and
inducing the production of free electrons in the doubly-doped macromolecular material.

179. The method of claim 178 wherein adding the first dopant comprises performing electrolysis, wherein the inducing comprises exposing the doubly-doped macromolecular material to radiation.

180. The method of claim 178 wherein adding the second dopant comprises performing electrolysis, wherein the inducing comprises exposing the doubly-doped macromolecular material to radiation.

181. A method comprising:
providing a macromolecular material;
adding a dopant to the macromolecular material to produce a doped macromolecular material, wherein the dopant reacts with the macromolecular material to create free radicals; and
inducing the production of free electrons in the doped macromolecular material.

182. The method of claim 181 wherein the created free radicals are in side chains of macromolecules of the macromolecular material.

183. The method of claim 181 wherein adding the dopant comprises electrolysis.

184. The method of claim 181 wherein the inducing comprises exposing the doped macromolecular material to radiation.

185. The method of claim 184 wherein the radiation is UV radiation.

186. A method comprising:
providing a macromolecular material;
placing an electrolyte in contact with the macromolecular material;
exposing the electrolyte and the macromolecular material to an electromagnetic field to induce ions from the electrolyte to diffuse into the macromolecular material;
inducing the formation of free electrons in the macromolecular material.

187. The method of claim 186 wherein the electrolyte is a salt solution.

188. The method of claim 186 wherein the electrolyte is a gel or a paste.

189. A device comprising a doped macromolecular material having a conductivity greater than 10⁶ S/cm.

190. The device of claim 189 wherein the macromolecular material is an enriched macromolecular material.

191. The device of claim 189 wherein the dopant is a material having an ionization potential below 6.95 eV.

192. The device of claim 189 wherein the dopant is a material having an ionization potential below 5.4 eV.

193. The device of claim 189 wherein the dopant is a material selected from the group consisting of inorganic molecules and radicals.

194. The device of claim 189 wherein the dopant is a material selected from the class of organic and element-organic compounds having ionization potentials below 6.95 eV.

195. The device of claim 189 wherein the dopant is a material selected from the class of 3d and 4f transition metals.
